(19) United States
(12) Patent Application Publication
(10) Pub. No.: US 2013/0050275 A1
(43) Pub. Date: Feb. 28, 2013

(54) POINTER POSITION CORRECTION METHOD, STORAGE MEDIUM STORING POINTER POSITION CORRECTION PROGRAM AND SERVER

(71) Applicants: Ryo Miyamoto, Kawasaki (JP); Kazuki Matsui, Kawasaki (JP)

(72) Inventors: Ryo Miyamoto, Kawasaki (JP); Kazuki Matsui, Kawasaki (JP)

(73) Assignee: FUJITSU LIMITED, Kawasaki-shi (JP)

(21) Appl. No.: 13/530,680

(22) Filed: Jun. 22, 2012

(30) Foreign Application Priority Data
Aug. 31, 2011 (JP) 2011-189651

(51) Int. Cl. G09G 5/08

(52) U.S. Cl. 345/672

(57) ABSTRACT

A pointer position correction method executed by a server, the correction method includes: receiving, from a client connected to the server through a network, first event information including an event that causes a pointer to move and a position to which to move the pointer, the event being input by the client; storing the first event information in an event record storage medium that stores a plurality of event information; executing processing according to the event that is included in the first event information; deciding whether, if the position of the pointer has been changed as a result of executing the processing, the changed pointer position matches any of pointer positions in the plurality of event information; and notifying the client of the changed pointer position if the changed pointer position does not match any of the pointer positions in the plurality of event information.

### CROSS-REFERENCE TO RELATED APPLICATION

This application is based upon and claims the benefit of priority of the prior Japanese Patent Application No. 2011-189651, filed on Aug. 31, 2011, the entire contents of which are incorporated herein by reference.

### FIELD

The embodiments discussed herein are related to a technology that corrects the position of a pointer.

### BACKGROUND

Thin client systems have attracted much attention to, for example, strengthen security and reduce total cost of ownership (TCO) in recent years. A thin client system includes a server and a client which are mutually connected through a network. What is manipulated on the client side is transferred through the network to the server. Processing results are then transferred from the server to the client and displayed on the screen of the client.

Communication protocols used between servers and clients in thin client systems are broadly classified into two types: command transfer method used in the Remote Desktop Protocol (RDP), which is a standard protocol of Windows®, and screen transfer method used in Virtual Network Computing (VNC) and the like. In the command transfer method, a drawing command for the desktop screen of the server is transferred to the client. Upon receipt of the drawing command, the client executes the drawing command to carry out drawing on the screen. In the screen transfer method, an image on the desktop screen of the server is transferred to the client as a bit map or an image in joint photographic experts group (JPEG) format or another image format, and the transferred image is displayed on the screen of the client.

When the command transfer method is used to display large quantities of objects during execution of a computer-aided design (CAD) program or the like, the number of drawing commands used is increased in proportion to the number of objects and a delay in manipulation is thereby prolonged. Therefore, the screen transfer method is more suitable than the command transfer method when large quantities of objects are displayed. In the screen transfer method, however, an important point in terms of ease of use is the drawing speed of a mouse cursor when the mouse is manipulated.

Methods of drawing a mouse cursor are classified into a server drawing method in the screen transfer method and a local echo method in the command transfer method. In the server drawing method, information about the mouse cursor drawn on the desktop screen of the server is transmitted to the client without alteration. The client receives the transmitted information and draws the mouse cursor on the screen on the client. FIG. 23 illustrates the server drawing method, which is a mouse cursor drawing method. As illustrated in FIG. 23, the client transmits an input event to the server. The server receives the transmitted input event, processes it, and transmits the resulting information about the mouse cursor to the client without alteration. The client receives the information about the mouse cursor and displays the movement result of the mouse cursor according to the received information about the mouse cursor.

In the local echo method, the client transmits an input event to the server and also draws the mouse cursor on the screen on the client. FIG. 24 illustrates the local echo method, which is another mouse cursor drawing method. As illustrated in FIG. 24, the client transmits an input event to the server and also draws the movement result of the mouse cursor on the screen. Therefore, the responsiveness of the mouse cursor in the local echo method, in which the processing result of the input event is not awaited, is better than in the server drawing method, in which the processing result of the input event is awaited.

A technology to reduce a communication frequency involved in mouse cursor movement in the server drawing method in the screen transfer method is disclosed in, for example, Japanese Laid-open Patent Publication No. 2010-211724. In this technology, the server creates drawing data, which is to be displayed, corresponding to the input event transmitted from the client to the server, and then creates a table in which cursor IDs are related to object area information included in the drawing data. The server transmits the created table and drawing data to the client. The client moves the mouse cursor in a state in which the drawing data corresponding to the input event is displayed. The client then determines, from the table, the cursor ID in the object area corresponding to the position to which the mouse cursor has been moved, and draws the shape of the mouse cursor corresponding to the cursor ID at the position to which the mouse cursor has been moved.

### SUMMARY

According to an aspect of the invention, a pointer position correction method executed by a server, the correction method includes: receiving, from a client connected to the server through a network, first event information including an event that causes a pointer to move and a position to which to move the pointer, the event being input by the client; storing the first event information in an event record storage medium that stores a plurality of event information; executing processing according to the event that is included in the first event information; deciding whether, if the position of the pointer has been changed as a result of executing the processing, the changed pointer position matches any of pointer positions in the plurality of event information stored in event record storage medium; and notifying the client of the changed pointer position if the changed pointer position does not match any of the pointer positions in the plurality of event information.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a functional block diagram illustrating the structure of a thin client system according to a first embodiment.

FIG. 2 illustrates an example of the structure of data retained in an event record storage unit.

FIG. 3 illustrates a specific example of mouse cursor position correction according to the first embodiment.

FIG. 4 is a flowchart of a procedure of input event processing executed by a client in the first embodiment.

FIG. 5 is a flowchart of a procedure of screen drawing processing executed by the client in the first embodiment.

FIG. 6 is a flowchart of a procedure of input event processing executed by a server in the first embodiment.

FIG. 7 is a flowchart of a procedure of cursor position correction processing executed by the server in the first embodiment.

FIG. 8 is a flowchart of a procedure of screen information transfer processing executed by the server in the first embodiment.

FIG. 9 is a functional block diagram illustrating the structure of a thin client system according to a second embodiment.

FIG. 10 illustrates a specific example of mouse cursor position correction according to the second embodiment.

FIG. 11 is a flowchart of a procedure of cursor position correction processing executed by a server in the second embodiment.

FIG. 12 is a functional block diagram illustrating the structure of a thin client system according to a third embodiment.

FIG. 13 illustrates a specific example of mouse cursor position correction according to the third embodiment.

FIG. 14 is a flowchart of a procedure of screen drawing processing executed by a client in the third embodiment.

FIG. 15 is a flowchart of a procedure of cursor position correction processing executed by a server in the third embodiment.

FIG. 16 illustrates a problem with a local echo method.

FIG. 17 is a functional block diagram illustrating the structure of a thin client system according to a fourth embodiment.

FIG. 18 illustrates a specific example of mouse cursor position correction according to the fourth embodiment.

FIG. 19 is a flowchart of a procedure of input event processing executed by a client in the fourth embodiment.

FIG. 20 is a flowchart of a procedure of cursor movement direction restricting processing executed by the client in the fourth embodiment.

FIGS. 21A and 21B are flowcharts of a procedure of cursor position correction processing executed by a server in the fourth embodiment.

FIG. 22 is an example of a computer that executes a cursor position correction program.

FIG. 23 illustrates a server drawing method, which is a mouse cursor drawing method.

FIG. 24 illustrates a local echo method, which is another mouse cursor drawing method.

### DESCRIPTION OF EMBODIMENTS

When the local echo method is used as the mouse cursor drawing method in the screen transfer method, however, if the position or shape of the mouse cursor is changed by the server, the client is unable to follow the change. That is because the client draws the mouse cursor by itself at the position according to the input event and transmits the input event to the server. When the position of the mouse cursor on the server side is automatically moved by, for example, an application, therefore, the client is unable to grasp the position to which the mouse cursor on the server side has been moved, so the client is unable to follow the change. This is also true when the shape of the mouse cursor is automatically changed on the server side.

In the disclosed technology in the server drawing method, when the client moves the mouse cursor, the shape of the mouse cursor is drawn according to the object area corresponding to the position to which the mouse cursor has been moved as described above. Even in the disclosed technology, therefore, when the shape of the mouse cursor is automatically changed, therefore, the client is unable to follow the change as in the case described above.

An object of the technology in the present disclosure is to enable the client to follow the change of the mouse cursor on the server side in the screen transfer method while the responsiveness of the mouse cursor in the local echo method is maintained.

Embodiments of a pointer position correction method, a pointer position correction program, and a server disclosed in the present disclosure will be described in detail with reference to the drawings. In these embodiments, a pointer will be described as a mouse cursor that moves when a mouse is manipulated. This present disclosure is not limited by these embodiments.

### First Embodiment

Structure of a Thin Client System

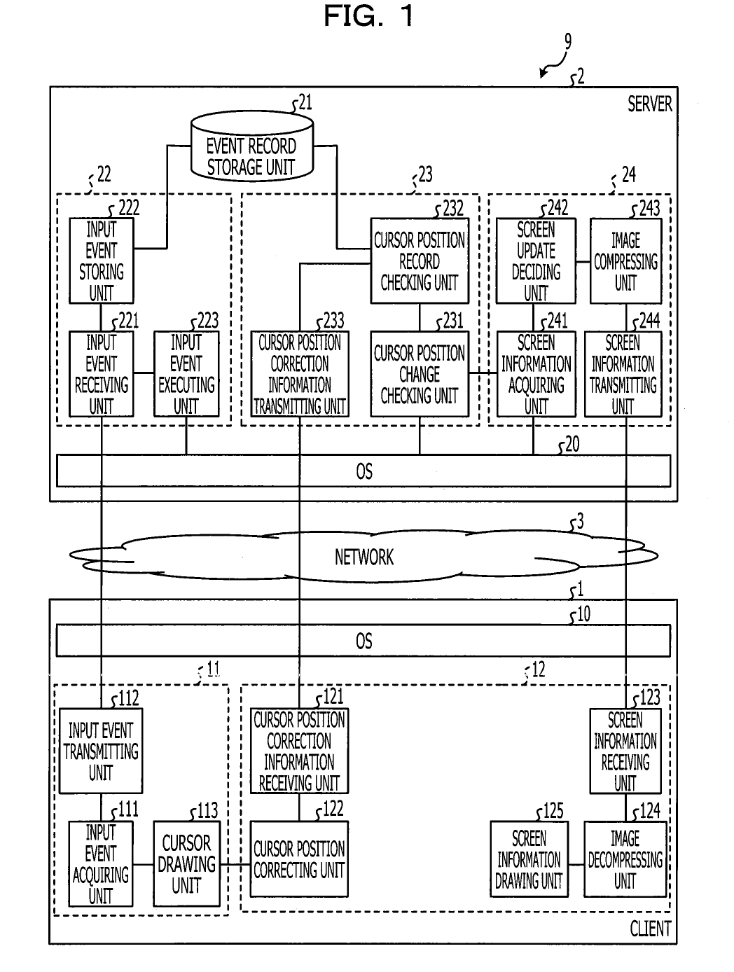

FIG. 1 is a functional block diagram illustrating the structure of a thin client system according to a first embodiment. The thin client system 9 in FIG. 1 causes a server 2 to remotely control the display of a desktop screen in a client 1. That is, in practice, the thin client system 9 causes the client 1 to display results of processing executed by the server 2. Accordingly, the thin client system 9 behaves as if the client 1 predominantly had executed processing.

As illustrated in FIG. 1, the thin client system 9 has the client 1 and server 2. Although, in the example in FIG. 1, one client 1 is connected to one server 2, any number of clients 1 can be connected.

The client 1 and server 2 are interconnected so as to communicate with each other via a network 3. The Internet, a local area network (LAN), a virtual private network (VPN), or any other type of communication network can be used as the network 3, regardless of whether the network is a wired network or a wireless network. The screen transfer method used in VNC is used as an example of the protocol between the server 2 and the client 1. That is, the contents of the desktop screen of the server 2 are transferred as a bit map or an image in JPEG or another image format to the client 1, and the transferred image is displayed on the desktop screen of the client 1.

The server 2 is a computer that remotely controls the screen to be displayed on the client 1 to display. The client 1 is a computer that undergoes remote screen control by the server 2. Not only a fixed terminal such as a personal computer but also a mobile terminal such as a mobile telephone, a personal handyphone system (PHS), or a personal digital assistant (PDA) can be used as an example of the client 1.

Structure of the Client

The client 1 includes an operating system (OS) 10, an event processing unit 11, and a drawing unit 12. The OS 10, which provides input and output functions involved in input from a mouse and keyboard and output to the screen, manages the entire client 1. Although an example of OS 10 is Windows®, another OS such as UNIX® may be used. The event processing unit 11 processes input events generated when the mouse or keyboard is manipulated. The event processing unit 11 includes an input event acquiring unit 111, an input event transmitting unit 112, and a cursor drawing unit 113. The drawing unit 12 receives information used to correct a mouse cursor position (cursor position correction information) from the server 2 and corrects the mouse cursor position according to it. The drawing unit 12 also receives image information from the server 2 and draws an image according to it. To achieve this, the drawing unit 12 includes a cursor position correction information receiving unit 121, a cursor position correcting unit 122, a screen information receiving unit 123, an image decompressing unit 124, and a screen information drawing unit 125.

The input event acquiring unit 111 acquires input events from input/output devices such as the keyboard and mouse connected to the client 1. The input event is, for example, an event in which the mouse cursor is moved by moving the mouse. An example of the input event is “MOUSE_MOVE X-coordinate of mouse cursor, Y-coordinate of mouse cursor, amount of wheel movement”. MOUSE_MOVE indicates how the mouse will be manipulated. In this example, it indicates that the mouse is to be moved. “X coordinate of mouse cursor” indicates the position of the X coordinate to which to move the mouse cursor, “Y coordinate of mouse cursor” indicates the position of the Y coordinate to which to move the mouse cursor, and “amount of wheel movement” indicates an amount by which a wheel, if used to move the mouse cursor, is to be moved. A specific example is “MOUSE_MOVE 800, 600, 0”, which indicates that the X coordinate of the mouse cursor is 800, the Y coordinate of the mouse cursor is 600, and the amount of wheel movement is 0.

The input event acquiring unit 111 causes the input event transmitting unit 112, described later, to transmit the acquired input event to the server 2 and also causes the cursor drawing unit 113, described later, to draw the mouse cursor at a post-processing position obtained after the processing of the event. The input event transmitting unit 112 transmits the input event acquired by the input event acquiring unit 111 to the server 2.

The cursor drawing unit 113 redraws the mouse cursor on the desktop screen of the client 1. For example, the cursor drawing unit 113 extracts the move-to position of the mouse cursor from the input event acquired by the input event acquiring unit 111. The cursor drawing unit 113 then draws the mouse cursor at the extracted mouse cursor position on the desktop screen of the client 1. That is, the event processing unit 11 transmits a generated input event to the server 2 and redraws the mouse cursor corresponding to the generated input event on the desktop screen of the client 1, as in the local echo method.

The cursor drawing unit 113 acquires a corrected position of the mouse cursor from the cursor position correcting unit 122, described later, and draws the mouse cursor at the acquired corrected position of the mouse cursor on the desktop screen of the client 1.

The cursor position correction information receiving unit 121 receives the cursor position correction information, which is information about the mouse cursor position to be corrected by the server 2, from the server 2. After the server 2 has processed the input event transmitted from the client 1, the post-processing position of the mouse cursor may be automatically changed by an OS. For example, automatic movement to a particular button may have been set depending on the manipulation of the OS. In this case, the cursor position correction information receiving unit 121 receives the cursor position correction information from the server 2 and causes the cursor drawing unit 113 to correct the mouse cursor position according to the received cursor position correction information to make a match in the mouse cursor position between the server 2 and client 1.

The cursor position correcting unit 122 extracts the corrected position of the mouse cursor from the cursor position correction information received by the cursor position correction information receiving unit 121. The cursor position correcting unit 122 also causes the cursor drawing unit 113 to redraw the mouse cursor at the extracted corrected position.

The screen information receiving unit 123 receives compressed image display data from the server 2. The image decompressing unit 124 decompresses the compressed image display data received by the screen information receiving unit 123. The screen information drawing unit 125 uses the image display data decompressed by the image decompressing unit 124 to redraw the contents of the screen. In this embodiment, image processing for other than the mouse cursor is carried out according to the image transfer method, so its description will be simplified.

Structure of the Server

The server 2 includes an OS 20, an event record storage unit 21, an event processing unit 22, a correcting unit 23, and a transfer unit 24. The OS 20, which provides a function of processing input events and other types of events, manages the entire server 2. Although an example of OS 20 is Windows®, another OS such as UNIX® may be used. The event record storage unit 21 retains event information in an input event received from the client 1 in a queue as an event record.

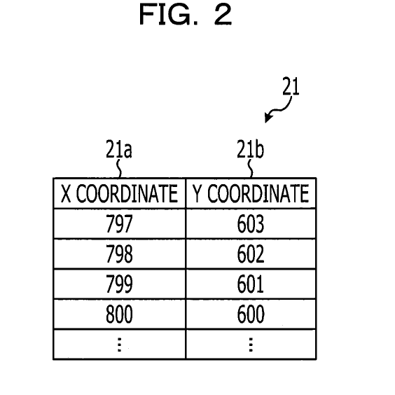

The structure of data retained in the event record storage unit 21 will be described with reference to FIG. 2. FIG. 2 illustrates an example of the structure of data retained in the event record storage unit 21. As illustrated in FIG. 2, the event record storage unit 21 retains input events as input event records with an X coordinate 21a and a Y coordinate 21b associated for each input event. The X coordinate 21a is the X coordinate of a move-to position included in the input event, and the Y coordinate 21b is the Y coordinate of the move-to position included in the input event. Input event records are retained in the order in which they were transmitted from the client 1 to the server 2. In the example in FIG. 2, an X coordinate of 797 and a Y coordinate of 603 are retained on the first line as the oldest input event record, and an X coordinate of 800 and a Y coordinate of 600 are retained on the fourth line as the newest input event record.

Referring again to FIG. 1, the event processing unit 22 receives an input event from the client 1 and processes it. The event processing unit 22 includes an input event receiving unit 221, an input event storing unit 222, and an input event executing unit 223. The correcting unit 23 uses the event record storage unit 21 to correct the mouse cursor position of the client 1. The correcting unit 23 includes a cursor position change checking unit 231, a cursor position record checking unit 232, and a cursor position correction information transmitting unit 233. The transfer unit 24 transfers image information to the client 1. The transfer unit 24 includes a screen information acquiring unit 241, a screen update deciding unit 242, an image compressing unit 243, and a screen information transmitting unit 244.

The input event receiving unit 221 receives an input event transmitted from the client 1. The input event storing unit 222 retains the input event received by the input event receiving unit 221 in the event record storage unit 21 as an input event record.

The input event executing unit 223 executes the input event received by the input event receiving unit 221. For example, the input event executing unit 223 sends the input event received by the input event receiving unit 221 to the OS 20 to have it execute the input event.

The cursor position change checking unit 231 decides whether the mouse cursor position has been changed as a result of input event execution by the input event executing unit 223. For example, the cursor position change checking unit 231 acquires, from the OS 20, the post-processing mouse cursor position obtained as a result of having the OS 20 process the input event. The cursor position change checking unit 231 then decides whether the acquired mouse cursor position matches the mouse cursor position before the input event has been processed. The cursor position change checking unit 231 makes this decision each time one frame of screen display data is updated, for example, each time the screen update deciding unit 242, described later, makes a decision.

If the cursor position change checking unit 231 decides that there is a change in the mouse cursor position after the event has been executed, the cursor position record checking unit 232 checks whether the changed mouse cursor position is being retained in the event record storage unit 21. For example, the cursor position record checking unit 232 decides whether the changed mouse cursor position matches any of the coordinate locations retained in the event record storage unit 21 as input event records.

If the cursor position record checking unit 232 decides that the changed mouse cursor position is being retained in the event record storage unit 21, the cursor position record checking unit 232 deletes the input event record decided to have been retained and earlier records. That is, since the mouse cursor position obtained as a result of the processing by the OS 20 has not been automatically changed by the OS 20, the cursor position record checking unit 232 deletes the record of the processed input event and earlier records. If the cursor position record checking unit 232 decides that the changed mouse cursor position is not being retained in the event record storage unit 21, the cursor position record checking unit 232 notifies the cursor position correction information transmitting unit 233 of the changed mouse cursor position. That is, the cursor position record checking unit 232 decides that the mouse cursor position obtained as a result of the processing by the OS 20 has been automatically changed by the OS 20 and notifies the cursor position correction information transmitting unit 233 of the changed mouse cursor position.

The cursor position correction information transmitting unit 233 transmits cursor position correction information including the mouse cursor position, of which the cursor position correction information transmitting unit 233 has been notified by the cursor position record checking unit 232, to the client 1. Thus, it is possible to have the client 1 correct the mouse cursor position automatically changed by the OS 20.

The screen information acquiring unit 241 causes the OS 20 to acquire screen display data. The screen update deciding unit 242 compares the previous screen display data and the most recent screen display data acquired by the screen information acquiring unit 241 and decides whether there is a screen display data update. If the screen update deciding unit 242 decides that there is a screen display data update, the image compressing unit 243 compresses screen display data in the updated area. The screen information transmitting unit 244 transmits the screen display data compressed by the image compressing unit 243 to the client 1.

Specific Example of Mouse Cursor Position Correction

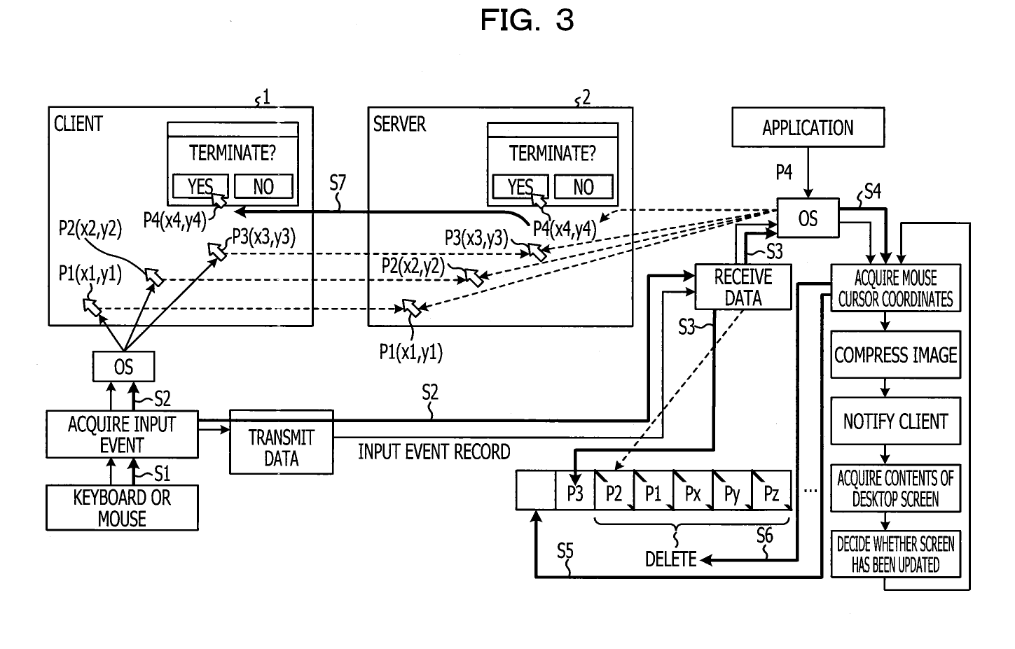

A specific example of mouse cursor position correction according to the first embodiment will be described with reference to FIG. 3.

As illustrated in FIG. 3, in the client 1, the input event acquiring unit 111 acquires an input event from the mouse connected to the client 1 (step S1). This example assumes that the input event is an event by which the mouse cursor is moved to a position (x2, y2) as a result of manipulating the mouse.

The input event acquiring unit 111 transfers the acquired input event to the input event transmitting unit 112 and cursor drawing unit 113. The input event transmitting unit 112 transmits the transferred input event to the server 2. The cursor drawing unit 113 causes the OS 10 to perform drawing according to the transferred input event on the desktop screen (step S2). In this example, the cursor drawing unit 113 draws the cursor at P2 on the desktop screen.

In the server 2, the input event receiving unit 221 receives the input event transmitted from the client 1. The input event storing unit 222 retains the input event received by the input event receiving unit 221 as an event record. In this example, the input event storing unit 222 retains coordinates P2, which is the move-to position included in the input event, as an event record. The input event executing unit 223 causes the OS 20 to execute the input event received by the input event receiving unit 221 (step S3).

The cursor position change checking unit 231 acquires the coordinates of the mouse cursor obtained as a result of the processing by the OS 20 (step S4). The cursor position change checking unit 231 then decides that the acquired coordinates P2 of the mouse cursor do not match the coordinates of the mouse cursor before the processing, that is, the mouse cursor has been moved. The cursor position record checking unit 232 then decides whether post-processing coordinates P2 of the mouse cursor is being retained as an input event record (step S5). Since, in this example, post-processing coordinates P2 of the mouse cursor is being retained, the cursor position record checking unit 232 deletes the record of coordinates P2 and earlier records (step S6). As described above, if, for example, the input event is an event by which the mouse is moved to coordinates P2, post-processing coordinates P2 of the mouse cursor have not been automatically changed by the OS 20, so the processing is terminated without the coordinates in the client 1 being corrected. As a result, the coordinates of the mouse cursor are drawn at P2 in the client 1 and server 2.

Next, a case in which the mouse cursor is moved to coordinates P3 (x3, y3) by an input event will be described. In the client 1, the input event acquiring unit 111 transfers the input event acquired from the mouse to the input event transmitting unit 112 and cursor drawing unit 113. The input event transmitting unit 112 transmits the transferred input event to the server 2. The cursor drawing unit 113 causes the OS 10 to perform drawing according to the transferred input event on the desktop screen (step S2). In this example, the cursor drawing unit 113 draws the cursor at P3 on the desktop screen.

In the server 2, the input event receiving unit 221 receives the input event transmitted from the client 1. The input event storing unit 222 retains the input event received by the input event receiving unit 221 as an event record. In this example, the input event storing unit 222 retains coordinates P3, which is the move-to position included in the input event, as an event record. The input event executing unit 223 causes the OS 20 to execute the input event received by the input event receiving unit 221 (step S3).

The cursor position change checking unit 231 acquires the coordinates of the mouse cursor obtained as a result of the processing by the OS 20 (step S4). This example assumes that the OS 20 has automatically changed the mouse cursor position from P3 to P4 (x4, y4). The cursor position change checking unit 231 then decides that the acquired coordinates P4 of the mouse cursor do not math coordinates P3 of the mouse cursor before the processing. The cursor position record checking unit 232 then decides whether post-processing coordinates P4 of the mouse cursor is being retained as an input event record (step S5). Since, in this example, post-processing coordinates P4 of the mouse cursor have been automatically changed from P3, which is the move-to position included in the input event, by the OS 20, coordinates P4 are not retained as an input event record. The cursor position record checking unit 232 then causes the cursor position correction information transmitting unit 233 to notify the client 1 of changed coordinates P4 of the mouse cursor (step S7).

In the client 1, the cursor position correction information receiving unit 121 receives changed coordinates P4 of the mouse cursor. The cursor position correcting unit 122 causes the cursor drawing unit 113 to redraw the mouse cursor at changed coordinates P4 of the mouse cursor. As described above, after the server 2 has processed an input event transmitted from the client 1, even if the post-processing coordinates of the mouse cursor are automatically changed by the OS 20, the client 1 can follow the changed coordinates.

Procedure of Input Event Processing in the Client

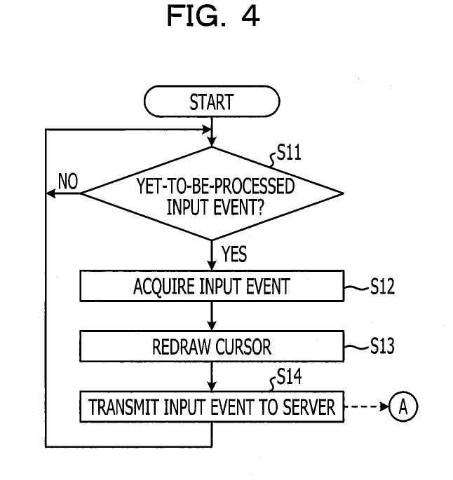

Next, a procedure of input event processing in the client 1 in the first embodiment will be described with reference to the flowchart illustrated in FIG. 4.

First, the input event acquiring unit 111 decides whether there is a yet-to-be-processed input event (step S11). If the input event acquiring unit 111 decides that there is no yet-to-be-processed input event (the result in step S11 is No), the input event acquiring unit 111 repeats this decision process until it decides that there is a yet-to-be-processed input event.

If the input event acquiring unit 111 decides that there is a yet-to-be-processed input event (the result in step S11 is Yes), the input event acquiring unit 111 acquires the input event (step S12). The cursor drawing unit 113 then redraws the mouse cursor on the desktop screen of the client 1 according to the input event acquired by the input event acquiring unit 111 (step S13). For example, the cursor drawing unit 113 extracts the move-to position of the mouse cursor from the input event and redraws the mouse cursor at the extracted mouse cursor position.

The input event transmitting unit 112 transmits the input event acquired by the input event acquiring unit 111 to the server 2 (step S14). The event processing unit 11 returns to step S11 to wait until a next event is generated.

Procedure of Screen Drawing Processing in the Client

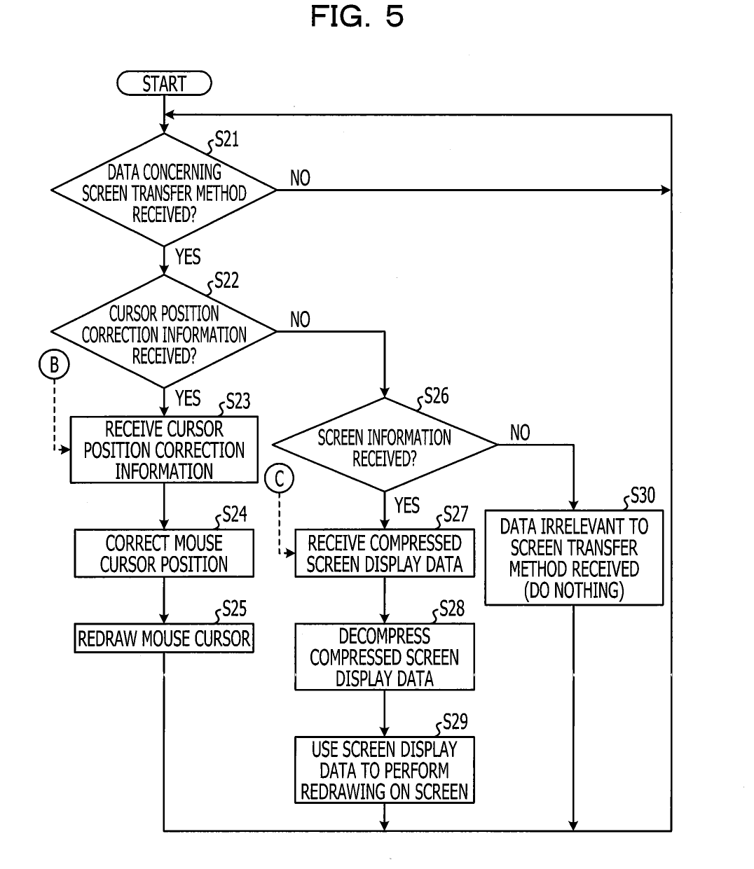

Next, a procedure of screen drawing processing in the client 1 in the first embodiment will be described with reference to the flowchart illustrated in FIG. 5.

First, the drawing unit 12 decides whether data concerning the screen transfer method has been received from the server 2 (step S21). If the drawing unit 12 decides that data concerning the screen transfer method has not been received (the result in step S21 is No), the drawing unit 12 repeats this decision process until it receives data concerning the screen transfer method.

If the drawing unit 12 decides that data concerning the screen transfer method has been received (the result in step S21 is Yes), the drawing unit 12 decides whether the cursor position correction information receiving unit 121 has received cursor position correction information (step S22). If the drawing unit 12 decides that the cursor position correction information receiving unit 121 has received the cursor position correction information (the result in step S22 is Yes), the cursor position correction information receiving unit 121 receives the cursor position correction information (step S23).

Next, the cursor position correcting unit 122 extracts a corrected position from the received cursor position correction information (step S24). The cursor drawing unit 113 redraws the mouse cursor at the corrected position (step S25). The drawing unit 12 returns to step S21 to wait for next data concerning the screen transfer method.

If the drawing unit 12 decides in step S22 that the cursor position correction information receiving unit 121 has not received the cursor position correction information (the result in step S22 is No), the drawing unit 12 decides whether the screen information receiving unit 123 has received screen information (step S26). If the drawing unit 12 decides that the screen information receiving unit 123 has received screen information (the result in step S26 is Yes), the screen information receiving unit 123 receives compressed screen display data (step S27).

Then, the image decompressing unit 124 decompresses the compressed screen display data (step S28). The screen information drawing unit 125 uses the decompressed screen display data to perform redrawing on the desktop screen (step S29). The drawing unit 12 then returns to step S21 to wait for next data concerning the screen transfer method.

If the drawing unit 12 decides in step S26 that the screen information receiving unit 123 has not received screen information (the result in step S26 is No), this indicates that the screen information receiving unit 123 has received data irrelevant to the screen transfer method, so nothing is carried out in this step (step S30). The drawing unit 12 returns to step S21 to wait for next data concerning the screen transfer method.

Procedure of Input Event Processing in the Server

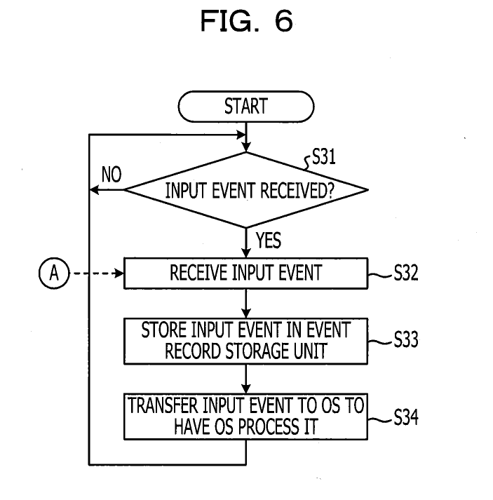

Next, a procedure of input event processing in the server 2 in the first embodiment will be described with reference to the flowchart illustrated in FIG. 6.

First, the input event receiving unit 221 in the server 2 decides whether an input event has been received from the client 1 (step S31). If the input event receiving unit 221 decides that an input event has not been received (the result in step S31 is No), the input event receiving unit 221 repeats this decision process until it receives an input event.

If the input event receiving unit 221 decides that an input event has been received (the result in step S31 is Yes), the input event receiving unit 221 receives the input event (step S32). Then, the input event storing unit 222 stores the received input event in the event record storage unit 21 as an input event record.

Next, the input event executing unit 223 transfers the input event to the OS 20 to have the OS 20 process it (step S34). The event processing unit 22 returns to step S31 to wait for a next event to be received.

Procedure of Cursor Position Correction Processing in the Server

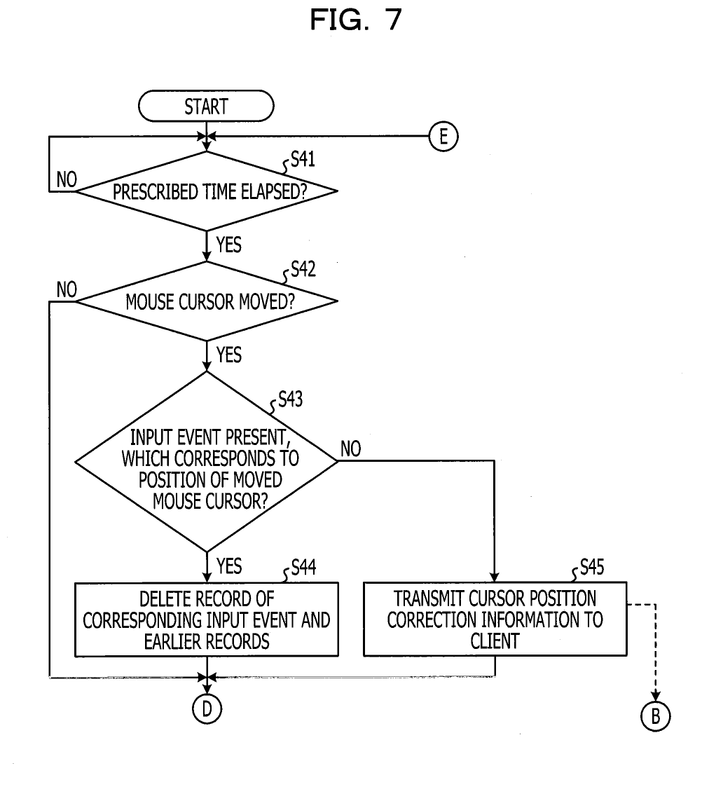

Next, a procedure of cursor position correction processing in the server 2 in the first embodiment will be described with reference to the flowchart illustrated in FIG. 7.

The cursor position change checking unit 231 decides whether a prescribed time has elapsed (step S41). If the cursor position change checking unit 231 decides that the prescribed time has not yet elapsed (the result in step S41 is No), the cursor position change checking unit 231 repeats this decision process until the prescribed time elapses.

If the cursor position change checking unit 231 decides that the prescribed time has elapsed (the result in step S41 is Yes), the cursor position change checking unit 231 checks whether the mouse cursor has been moved (step S42). For example, the cursor position change checking unit 231 acquires, from the OS 20, the post-processing mouse cursor position obtained as a result of having the OS 20 process the input event. The cursor position change checking unit 231 then decides whether the acquired mouse cursor position matches the mouse cursor position before the input event has been processed. The prescribed time is, for example, an interval at which one frame of screen display data is updated; an example of the prescribed time is 33 ms.

If the cursor position change checking unit 231 decides that the mouse cursor has not been moved (the result in step S42 is No), the correcting unit 23 terminates cursor position correction processing and shifts to screen information transfer processing. If the cursor position change checking unit 231 decides that the mouse cursor has been moved (the result in step S42 is Yes), the cursor position record checking unit 232 decides whether there is an input event corresponding to the position of the moved mouse cursor (step S43). For example, the cursor position record checking unit 232 decides whether the changed mouse cursor position matches any of the coordinate locations retained in the event record storage unit 21 as input event records.

If the cursor position record checking unit 232 decides that there is a corresponding input event (the result in step S43 is Yes), the cursor position record checking unit 232 deletes the record of the corresponding input event and earlier records (step S44). Then, the correcting unit 23 terminates cursor position correction processing and shifts to screen information transfer processing.

If the cursor position record checking unit 232 decides that there is no corresponding input event (the result in step S43 is No), the cursor position record checking unit 232 decides that the mouse cursor position has been automatically changed by the OS 20. The cursor position record checking unit 232 then causes the cursor position correction information transmitting unit 233 to transmit cursor position correction information to the client 1 (step S45). For example, the cursor position correction information transmitting unit 233 transmits, to the client 1, cursor position correction information including the changed mouse cursor position. Then, the correcting unit 23 terminates cursor position correction processing and shifts to screen information transfer processing.

Procedure of Screen Information Transfer Processing in the Server

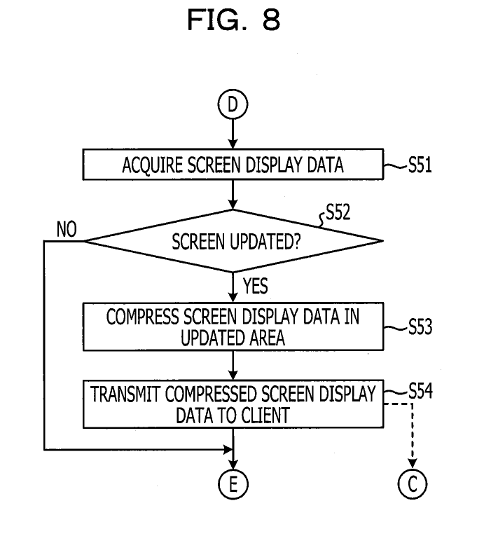

Next, a procedure of screen information transfer processing in the server 2 in the first embodiment will be described with reference to the flowchart illustrated in FIG. 8.

The screen information acquiring unit 241 causes the OS 20 to acquire screen display data (step S51). The screen update deciding unit 242 compares the acquired screen display data with the previous screen display data and decides whether there is a screen display data update (step S52). If the screen update deciding unit 242 decides that there is no screen display data update (the result in step S52 is No), the transfer unit 24 returns to step S41 to carry out cursor position correction processing.

If the screen update deciding unit 242 decides that there is a screen display data update (the result in step S52 is Yes), the image compressing unit 243 compresses screen display data in the updated area (step S53). The screen information transmitting unit 244 transmits the compressed screen display data to the client 1 (step S54). The transfer unit 24 then returns to step S41 to carry out cursor position correction processing.

Advantages in the First Embodiment

In the first embodiment described above, for an input event, received from the client 1, that causes the mouse cursor to move, the server 2 in the thin client system 9 stores event information including a position to which to move the mouse cursor in the event record storage unit 21. If the mouse cursor position is changed as a result of processing carried out according to the input event, the server 2 decides whether the changed mouse cursor position matches any of the mouse cursor positions retained in the event record storage unit 21. If the server 2 decides that the changed mouse cursor position does not match any of the mouse cursor positions retained in the event record storage unit 21, the server 2 notifies the client 1 of the changed mouse cursor position. Accordingly, even if the mouse cursor position changed in processing based on an input event received from the client 1 is automatically changed in processing, the server 2 enables the client 1 to follow the changed mouse cursor position.

In the first embodiment above, if the server 2 decides that the changed mouse cursor position matches any of the mouse cursor positions retained in the event record storage unit 21, the server 2 deletes the event information in the event related to the matching cursor position and earlier event information. Accordingly, the server 2 can reduce the number of comparisons with the mouse cursor positions retained in the event record storage unit 21, increasing processing efficiency.

### Second Embodiment

In the first embodiment, a case has been described in which if the server 2 decides that the changed mouse cursor position obtained after input event processing is being retained in the event record storage unit 21, the server 2 deletes the input event record decided to have been retained and earlier records. In the case in which the server 2 decides that the changed mouse cursor position is being retained in the event record storage unit 21, however, if a retained queue is long, the server 2 may adjust a processing interval in the screen transfer method before deleting the records.

That is, the server 2 may have a high processing load involved in the screen transfer method. If the processing load is increased, the server 2 may take much time to process the input event transmitted from the client 1 and the queue length of input events to be retained in the event record storage unit 21 may be prolonged. When the queue length is longer than a threshold, therefore, the server 2 may adjust the processing interval in the screen transfer method to lower the processing load.

The server 2 in a second embodiment will be described below that adjusts the processing interval in the screen transfer method when the length of the queue length of input events to be retained in the event record storage unit 21 is longer than the threshold.

Structure of a Thin Client System

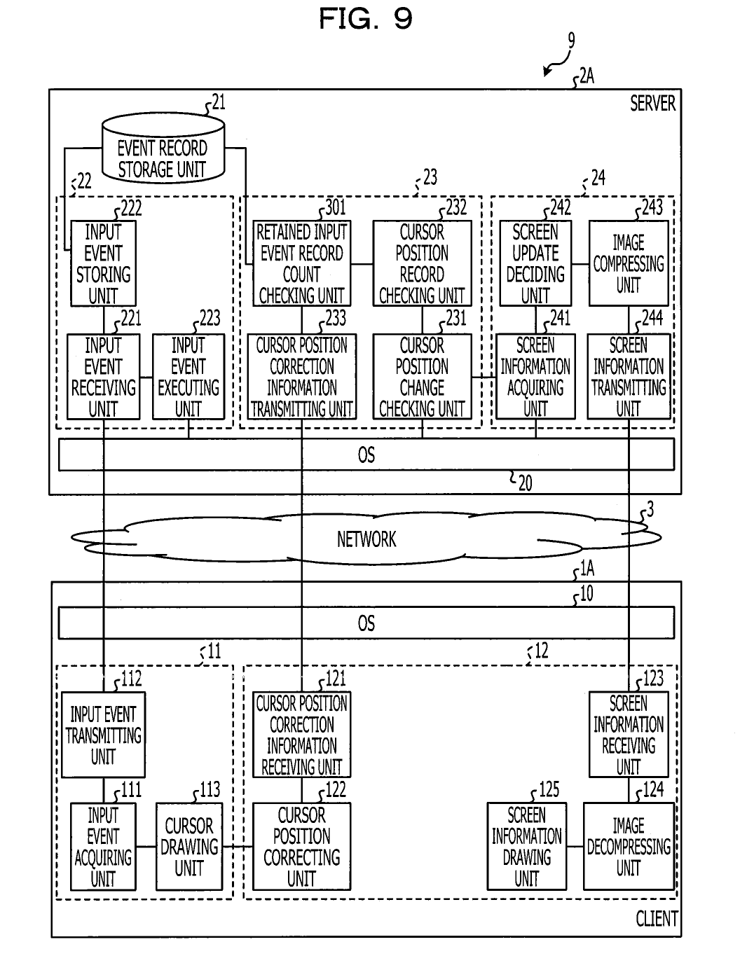

FIG. 9 is a functional block diagram illustrating the structure of a thin client system according to a second embodiment. Constituent elements that are the same as in the thin client system 9 illustrated in FIG. 1 will be given the same reference numerals and descriptions of duplicate structures and operations will be omitted. The second embodiment differs from the first embodiment in that a retained input event record count checking unit 301 is added to the correcting unit 23 in a server 2A.

The cursor position record checking unit 232 checks whether a changed mouse cursor position obtained after the execution of the input event is being retained in the event record storage unit 21.

If the changed mouse cursor position is being retained in the event record storage unit 21, the retained input event record count checking unit 301 decides whether the queue length of input events retained in the event record storage unit 21 is equal to or longer than a threshold. For example, the retained input event record count checking unit 301 counts the number of input events in the event record storage unit 21, starting from an input event related to a coordinate position that matches the changed mouse cursor position and proceeding toward earlier input events. The retained input event record count checking unit 301 also decides whether the counted number of input events is larger than a threshold. If the retained input event record count checking unit 301 decides that the counted number of input events is larger than the threshold, the retained input event record count checking unit 301 decides that the processing load is high and thereby prolongs the current processing interval in the screen transfer method. If the retained input event record count checking unit 301 decides that the counted number of input events is equal to or smaller than the threshold, the retained input event record count checking unit 301 decides that the processing load is low and thereby shortens the current processing interval in the screen transfer method or leaves it unchanged. The retained input event record count checking unit 301 then deletes the record of the input event related to the matching coordinate position and earlier records.

Although the threshold with which the number of input event is compared is, for example, 3, the threshold may be changed according the throughput of the central processing unit (CPU); the threshold may be any value by which it is decided that if the threshold is exceeded, the processing load becomes high. The processing interval in the screen transfer method refers to a screen update interval (update frequency). That is, the processing interval matches a prescribed time that is a time interval at which the cursor position change checking unit 231 checks whether the mouse cursor has been moved. The longer the processing interval in the screen transfer method is, the longer the prescribed time is; the shorter the processing interval in the screen transfer method is, the shorter the prescribed time is.

Specific Example of Mouse Cursor Position Correction

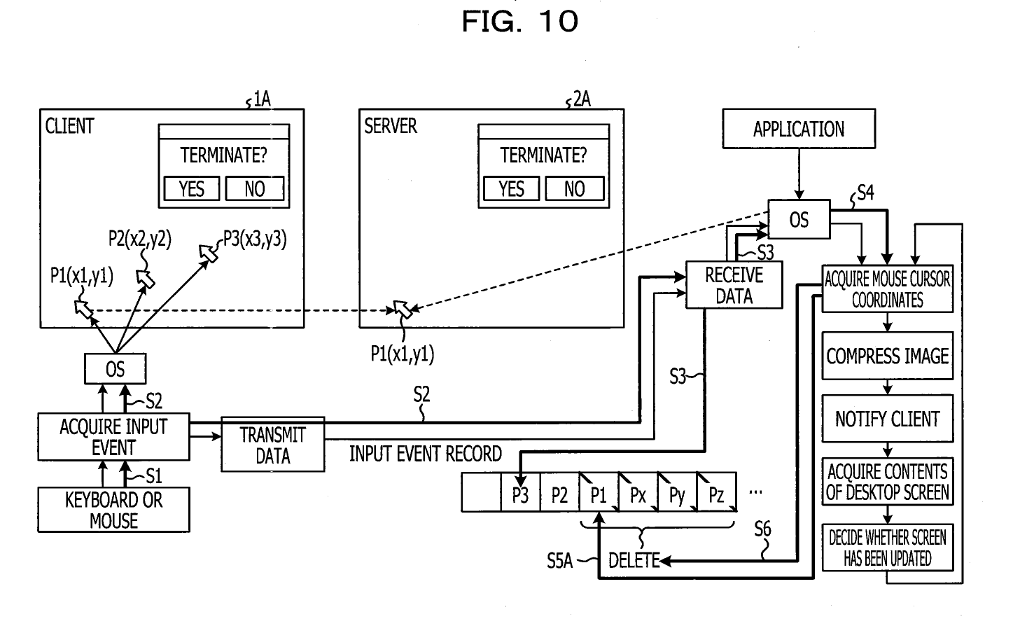

A specific example of mouse cursor position correction according to the second embodiment will be described with reference to FIG. 10.

As illustrated in FIG. 10, in the client 1A, the input event acquiring unit 111 acquires input events from the mouse connected to the client 1A (step S1). This example assumes that three input events are used to move the mouse cursor to (x1, y1), (x2, y2), and (x3, y3) in time series by manipulating the mouse.

The input event acquiring unit 111 acquires these input events in time series. Each time the input event acquiring unit 111 acquires an input event, it transfers the acquired input event to the input event transmitting unit 112 and the cursor drawing unit 113. The input event transmitting unit 112 transmits the transferred input event to the server 2A. The cursor drawing unit 113 causes the OS 10 to perform drawing according to the transferred input event on the desktop screen (step S2). In this example, the cursor drawing unit 113 draws the mouse cursor at P1, P2, and P3 on the desktop screen in that order.

In the server 2A, the input event receiving unit 221 receives the input events transmitted from the client 1A in time series. The input event storing unit 222 retains the input events received by the input event receiving unit 221 as event records. In this example, the input event storing unit 222 retains coordinates P1, P2, and P3, which are the move-to positions included in the input events, as event records. The input event executing unit 223 causes the OS 20 to execute the input events received by the input event receiving unit 221 (step S3).

The cursor position change checking unit 231 acquires the coordinates of the mouse cursor obtained as a result of the processing by the OS 20 (step S4). The cursor position change checking unit 231 then decides that the acquired coordinates P1 of the mouse cursor do not match the coordinates of the mouse cursor before the processing, that is, the mouse cursor has been moved. The cursor position record checking unit 232 then decides whether post-processing coordinates P1 of the mouse cursor is being retained as the input event record. In this example, the cursor position record checking unit 232 decides that post-processing coordinates P1 of the mouse cursor is being retained as the input even record. Then, the retained input event record count checking unit 301 checks the queue length of the corresponding input event and earlier events in the input event records to see that the queue length is longer than the threshold (step S5A). Since there are four input events (corresponding to P1, Px, Py, and Pz) as the input events corresponding to P1 and earlier input events, the queue length is 4. If the threshold is 3, the queue length, which is 4, is decided to be longer the threshold, which is 3.

Since the retained input event record count checking unit 301 has decided that the queue length is longer the threshold, the retained input event record count checking unit 301 decides that the processing load is high and thereby prolongs the processing interval in the screen transfer method. The retained input event record count checking unit 301 then deletes the record of the input event related to post-processing coordinates P1 of the mouse cursor and earlier records (step S6). In this example, the records of the input events related to P1, Px, Py, and Pz are deleted. Processing by the transfer unit 24 is executed next. As described above, when the queue length of input events is long, the server 2A can decide that the processing load is high and can reduce the processing load by prolonging the processing interval in the screen transfer method, improving maneuverability.

Procedure of Cursor Position Correction Processing in the Server

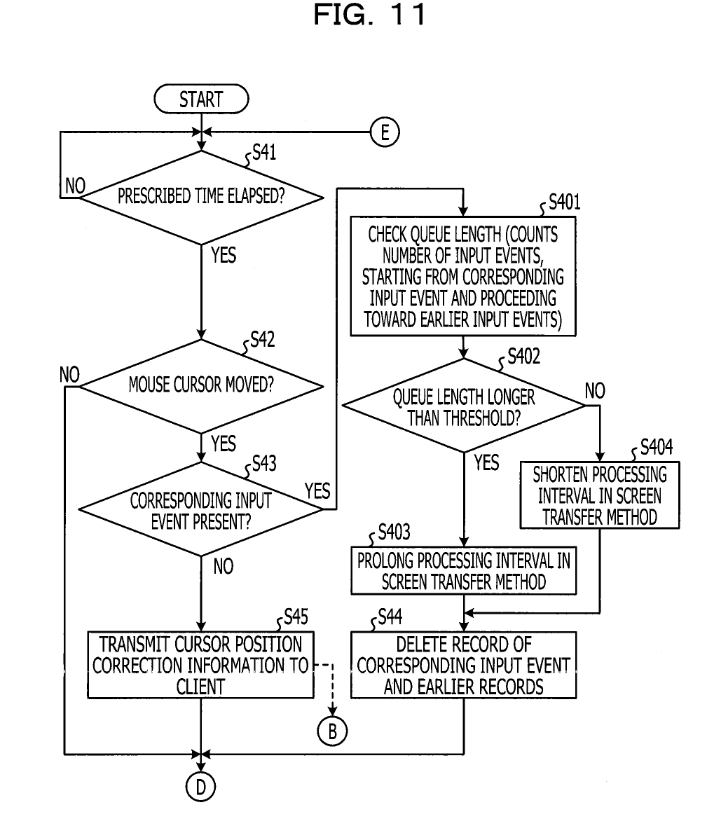

Next, a procedure of cursor position correction processing in the server 2A in the second embodiment will be described with reference to the flowchart illustrated in FIG. 11. The same processes as in cursor position correction processing executed by the server 2 in the first embodiment in FIG. 7 will be given the same symbols.

The cursor position change checking unit 231 decides whether a prescribed time has elapsed (step S41). If the cursor position change checking unit 231 decides that the prescribed time has not yet elapsed (the result in step S41 is No), the cursor position change checking unit 231 repeats this decision process until the prescribed time elapses.

If the cursor position change checking unit 231 decides that the prescribed time has elapsed (the result in step S41 is Yes), the cursor position change checking unit 231 checks whether the mouse cursor has been moved (step S42). For example, the cursor position change checking unit 231 acquires, from the OS 20, the post-processing mouse cursor position obtained as a result of having the OS 20 process the input event. The cursor position change checking unit 231 then decides whether the acquired mouse cursor position matches the mouse cursor position before the input event has been processed (step S42). The prescribed time is, for example, an interval at which one frame of screen display data is updated.

If the cursor position change checking unit 231 decides that the mouse cursor has not been moved (the result in step S42 is No), the correcting unit 23 terminates cursor position correction processing and shifts to screen information transfer processing. If the cursor position change checking unit 231 decides that the mouse cursor has been moved (the result in step S42 is Yes), the cursor position record checking unit 232 decides whether there is an input event corresponding to the position of the moved mouse cursor (step S43). For example, the cursor position record checking unit 232 decides whether the changed mouse cursor position matches any of the coordinate locations retained in the event record storage unit 21 as input event records.

If the cursor position record checking unit 232 decides that there is a corresponding input event (the result in step S43 is Yes), the retained input event record count checking unit 301 counts the number of input events, starting from the corresponding input event and proceeding toward earlier input events (checks the queue length) (step S401). For example, the retained input event record count checking unit 301 counts the number of input events in the event record storage unit 21, starting from an input event related to a coordinate position that matches the changed mouse cursor position and proceeding toward earlier input events.

The retained input event record count checking unit 301 then decides whether the queue length is longer than the threshold (step S402). If the retained input event record count checking unit 301 decides that the queue length is longer than the threshold (the result in step S402 is Yes), the retained input event record count checking unit 301 decides that the processing load is high and thereby prolongs the processing interval in the screen transfer method (step S403).

If the retained input event record count checking unit 301 decides that the queue length is equal to or shorter than the threshold (the result in step S402 is No), the retained input event record count checking unit 301 decides that the processing load is low and thereby shortens the current processing interval in the screen transfer method (step S404). The retained input event record count checking unit 301 then deletes the record of the corresponding input event and earlier records (step S44). The correcting unit 23 terminates cursor position correction processing and shifts to screen information transfer processing.

Returning to step S43, if the cursor position record checking unit 232 decides that there is no corresponding input event (the result in step S43 is No), the cursor position record checking unit 232 decides that the mouse cursor position has been automatically changed by the OS 20. The cursor position record checking unit 232 then causes the cursor position correction information transmitting unit 233 to transmit cursor position correction information to the client 1A (step S45). For example, the cursor position correction information transmitting unit 233 transmits, to the client 1A, cursor position correction information including the changed mouse cursor position. Then, the correcting unit 23 terminates cursor position correction processing and shifts to screen information transfer processing.

Advantages in the Second Embodiment

In the second embodiment described above, for an input event, received from the client 1A, that causes the mouse cursor to move, the server 2A in the thin client system 9 stores event information including a position to which to move the mouse cursor in the event record storage unit 21. If the mouse cursor position is changed as a result of processing carried out according to the input event, the server 2A decides whether the changed mouse cursor position matches any of the mouse cursor positions retained in the event record storage unit 21. If the server 2A decides that the changed mouse cursor position matches any of the mouse cursor positions retained in the event record storage unit 21, the server 2A decides whether the number of input events, starting from the input event related to the matching mouse cursor position and proceeding toward earlier input events, is larger than the threshold. If the server 2A decides that that number of input events is larger than the threshold, the server 2A prolongs the current processing interval in the screen transfer method. Accordingly, if the number of relevant events retained in the event record storage unit 21 is larger than the threshold, indicating that the interval at which processing of input events involving cursor position movement is prolonged, the server 2A assumes that its processing load is high. In this case, the server 2A can lower the processing load by prolonging the processing interval in the screen transfer method, improving maneuverability of the thin client system 9.

### Third Embodiment

In the first embodiment, a case has been described in which when the mouse cursor is automatically moved as a result of input event processing, the position of the automatically moved mouse cursor is transmitted to the client 1. However, the server 2 is not limited to this; when the mouse cursor is automatically moved, not only the position of the automatically moved mouse cursor but also its shape may be transmitted to the client 1. This is because when the mouse cursor position is automatically changed, the shape of the mouse cursor may also change depending on the position to which the mouse cursor has been moved.

The server 2 in a third embodiment will be described below that transmits, to the client 1, the position and shape of the mouse cursor that has been automatically moved.

Structure of a Thin Client System

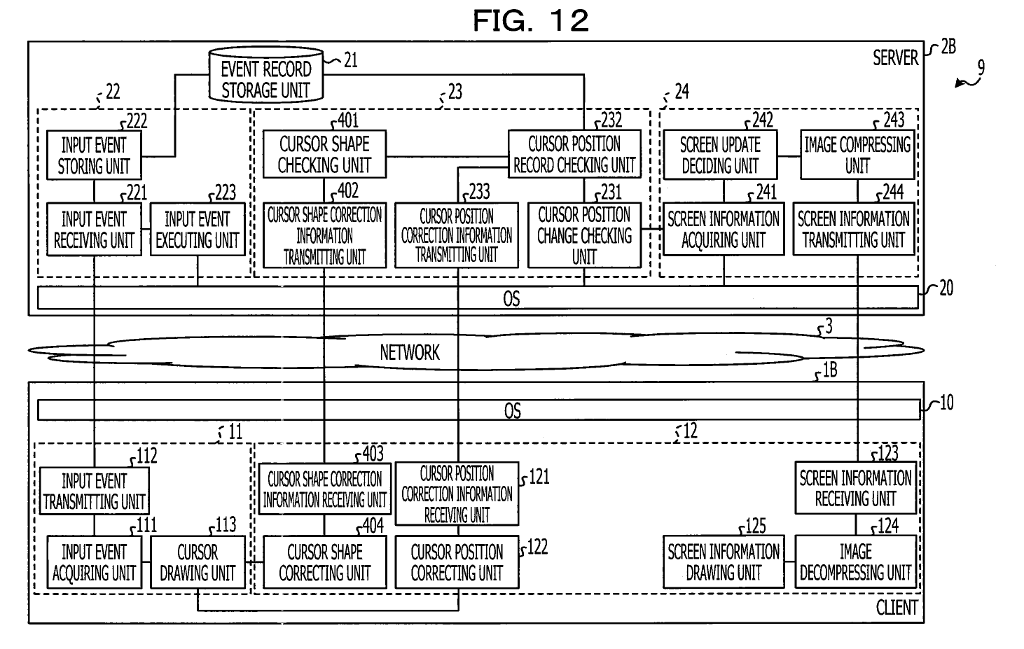

FIG. 12 is a functional block diagram illustrating the structure of a thin client system according to a third embodiment. Constituent elements that are the same as in the thin client system 9 illustrated in FIG. 1 will be given the same reference numerals and descriptions of duplicate structures and operations will be omitted. The third embodiment differs from the first embodiment in that a cursor shape checking unit 401 and a cursor shape correction information transmitting unit 402 are added to the correcting unit 23 in a server 2B. Another difference from the first embodiment is that a cursor shape correction information receiving unit 403 and a cursor shape correcting unit 404 are added to the drawing unit 12 in a client 1B.

The cursor position record checking unit 232 checks whether a changed mouse cursor position obtained after the execution of the input event is being retained in the event record storage unit 21.

If the changed mouse cursor position is not being retained in the event record storage unit 21, the cursor shape checking unit 401 further checks whether the shape of the mouse cursor has been changed. For example, the cursor shape checking unit 401 uses the OS 20 to check whether the shape of the mouse cursor has been changed. If the cursor shape checking unit 401 decides that the shape of the mouse cursor has been changed, the cursor shape checking unit 401 notifies the cursor shape correction information transmitting unit 402 of the changed mouse cursor shape. That is, if the shape of the mouse cursor is also changed when its position is automatically changed by the OS 20, the cursor shape checking unit 401 notifies the cursor shape correction information transmitting unit 402 of the changed shape.

The cursor shape correction information transmitting unit 402 transmits, to the client 1B, cursor shape correction information including the cursor shape received from the cursor shape checking unit 401. The server 2B can then cause the client 1B to correct the mouse cursor shape that has been changed when the mouse cursor position was automatically changed by the OS 20.

The cursor shape correction information receiving unit 403 receives the cursor shape information from the server 2B. The cursor shape correction information is cursor shape information corrected by the server 2B. That is, in the server 2B, the position and shape of the mouse cursor may be automatically changed by the OS 20 as a result of processing an input event transmitted from the client 1B. In this case the cursor shape correction information receiving unit 403 receives the cursor shape correction information from the server 2B and causes the cursor shape correcting unit 404 to correct the cursor shape according to the received cursor shape correction information so that a match with the cursor shape in the server 2B is obtained.

The cursor shape correcting unit 404 extracts the corrected shape of the mouse cursor from the cursor shape correction information received by the cursor shape correction information receiving unit 403. The cursor shape correcting unit 404 also redraws the mouse cursor having the extracted corrected shape on the cursor drawing unit 113.

Specific Example of Mouse Cursor Position Correction

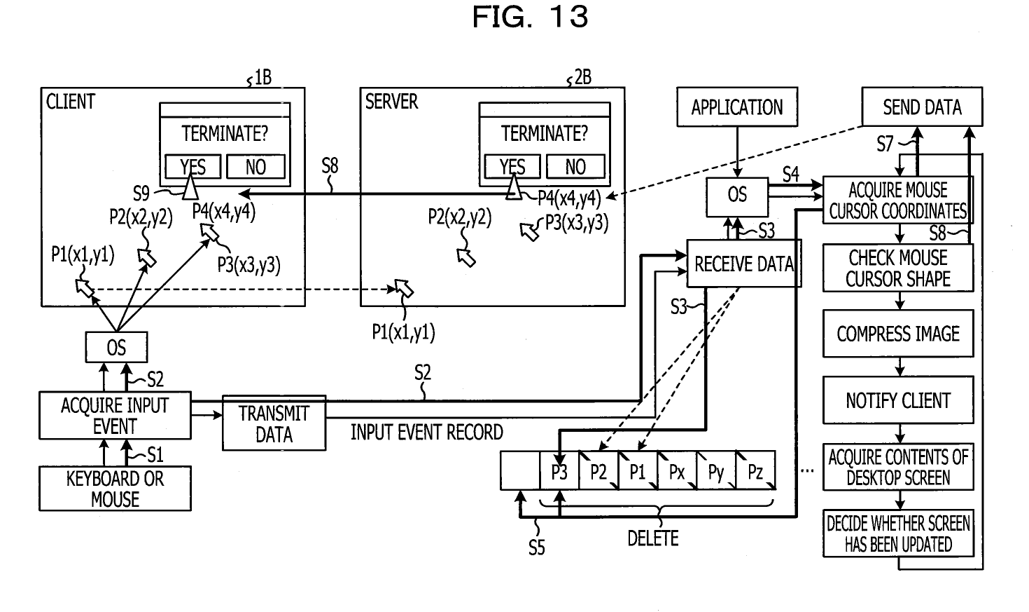

A specific example of mouse cursor position correction according to the third embodiment will be described with reference to FIG. 13. In FIG. 13, the server 2B receives, from the client 1B, input events by which the position at which the mouse cursor is displayed is changed when the mouse is moved. This example assumes that, for the input events by which the mouse cursor is changed to P1 and then P2, the mouse cursor is not automatically changed by the OS 20 after the input events have been processed. This example also assumes that, for an input event by which the mouse cursor is moved from P2 to P3, the mouse cursor position is automatically changed from P3 to P4 by the OS 20 after the input event has been processed and the cursor shape is also changed from an arrow to a triangle. A case in which the input event by which the mouse cursor is changed from P2 to P3 is used will be described below.

As illustrated in FIG. 13, in the client 1B, the input event acquiring unit 111 acquires input events from the mouse connected to the client 1B (step S1). This example assumes that the input event acquiring unit 111 acquires an input event by which the mouse cursor is moved to (x3, y3) as a result of manipulating the mouse.

The input event acquiring unit 111 transfers the acquired input event to the input event transmitting unit 112 and cursor drawing unit 113. The input event transmitting unit 112 transmits the transferred input event to the server 2B. The cursor drawing unit 113 causes the OS 10 to perform drawing according to the transferred input event on the desktop screen (step S2). In this example, the cursor drawing unit 113 draws the cursor at P3 on the desktop screen.

In the server 2B, the input event receiving unit 221 receives the input event transmitted from the client 1B. The input event storing unit 222 retains the input event received by the input event receiving unit 221 as an event record. In this example, the input event storing unit 222 retains coordinates P3, which is the move-to position included in the input event, as an event record. The input event executing unit 223 causes the OS 20 to execute the input event received by the input event receiving unit 221 (step S3).

The cursor position change checking unit 231 acquires the coordinates of the mouse cursor obtained as a result of the processing by the OS 20 (step S4). In this example, the OS 20 has automatically changed the mouse cursor position from P3 to P4 (x4, y4). The cursor position change checking unit 231 then decides that the changed coordinates P4 do not match coordinates P3 of the mouse cursor before the processing. The cursor position record checking unit 232 then decides whether post-processing coordinates P4 of the mouse cursor is being retained as an input event record (step S5). Since, in this example, post-processing coordinates P4 of the mouse cursor are coordinates automatically changed from P3 by the OS 20, coordinates P4 has not been retained as an input event record. The cursor position record checking unit 232 then causes the cursor position correction information transmitting unit 233 to notify the client 1B of changed coordinates P4 of the mouse cursor (step S7).

The cursor shape checking unit 401 uses the OS 20 to decide whether the shape of the mouse cursor has been changed. In this example, the post-processing shape of the mouse cursor has been changed from an arrow to a triangle. Accordingly, the cursor shape checking unit 401 causes the cursor shape correction information transmitting unit 402 to transmit a notification of the changed mouse cursor shape, which is a triangle (step S8).

In the client 1B, the cursor position correction information receiving unit 121 receives changed coordinates P4 of the mouse cursor. The cursor position correcting unit 122 causes the cursor drawing unit 113 to redraw the mouse cursor at changed coordinates P4 of the mouse cursor. Next, the cursor shape correction information receiving unit 403 receives the changed mouse cursor shape, and the cursor shape correcting unit 404 causes the cursor drawing unit 113 to redraw the changed mouse cursor.

As described above, after the server 2B has processed an input event transmitted from the client 1B, even if the post-processing shape of the mouse cursor is automatically changed, the client 1B can follow the changed shape of the mouse cursor.

Procedure of Screen Drawing Processing in the Client

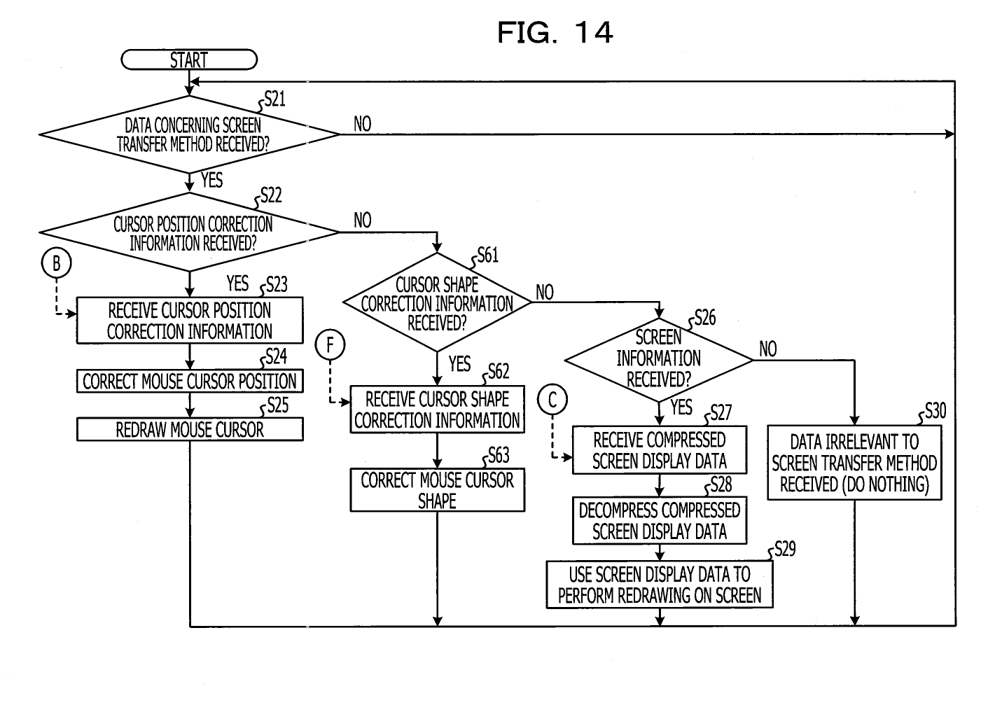

Next, a procedure of screen drawing processing in the client 1B in the third embodiment will be described with reference to the flowchart illustrated in FIG. 14. The same processes as in screen drawing processing executed by the server 2 in the first embodiment in FIG. 5 will be given the same symbols.

First, the drawing unit 12 decides whether data concerning the screen transfer method has been received from the server 2B (step S21). If the drawing unit 12 decides that data concerning the screen transfer method has not been received (the result in step S21 is No), the drawing unit 12 repeats this decision process until it receives data concerning the screen transfer method.

If the drawing unit 12 decides that data concerning the screen transfer method has been received (the result in step S21 is Yes), the drawing unit 12 decides whether the cursor position correction information receiving unit 121 has received cursor position correction information (step S22). If the drawing unit 12 decides that the cursor position correction information receiving unit 121 has received the cursor position correction information (the result in step S22 is Yes), the cursor position correction information receiving unit 121 receives the cursor position correction information (step S23).

Next, the cursor position correcting unit 122 extracts a corrected position from the received cursor position correction information (step S24). The cursor drawing unit 113 redraws the mouse cursor at the corrected position (step S25). The drawing unit 12 returns to step S21 to wait for next data concerning the screen transfer method.

If the drawing unit 12 decides in step S22 that the cursor position correction information receiving unit 121 has not received the cursor position correction information (the result in step S22 is No), the drawing unit 12 decides whether the cursor shape correction information receiving unit 403 has received cursor shape correction information (step S61). If the drawing unit 12 decides that the cursor shape correction information receiving unit 403 has received cursor position correction information (the result in step S61 is Yes), the cursor shape correction information receiving unit 403 receives the cursor shape correction information (step S62).

Then, the cursor shape correcting unit 404 extracts the corrected shape from the received cursor shape correction information and corrects the mouse cursor shape to the extracted corrected shape (step S63). The drawing unit 12 then returns to step S21 to wait for next data concerning the screen transfer method.

If the drawing unit 12 decides in step S61 that the cursor shape correction information receiving unit 403 has not received cursor shape correction information (the result in step S61 is No), the drawing unit 12 decides whether the screen information receiving unit 123 has received screen information (step S26). If the drawing unit 12 decides that the screen information receiving unit 123 has received screen information (the result in step S26 is Yes), the screen information receiving unit 123 receives compressed screen display data (step S27).

Then, the image decompressing unit 124 decompresses the compressed screen display data (step S28). The screen information drawing unit 125 uses the decompressed screen display data to perform redrawing on the desktop screen (step S29). The drawing unit 12 then returns to step S21 to wait for next data concerning the screen transfer method.

If the drawing unit 12 decides in step S26 that the screen information receiving unit 123 has not received screen information (the result in step S26 is No), this indicates that the screen information receiving unit 123 has received data irrelevant to the screen transfer method, so nothing is carried out in this step (step S30). The drawing unit 12 returns to step S21 to wait for next data concerning the screen transfer method.

Procedure of Cursor Position Correction Processing in the Server.

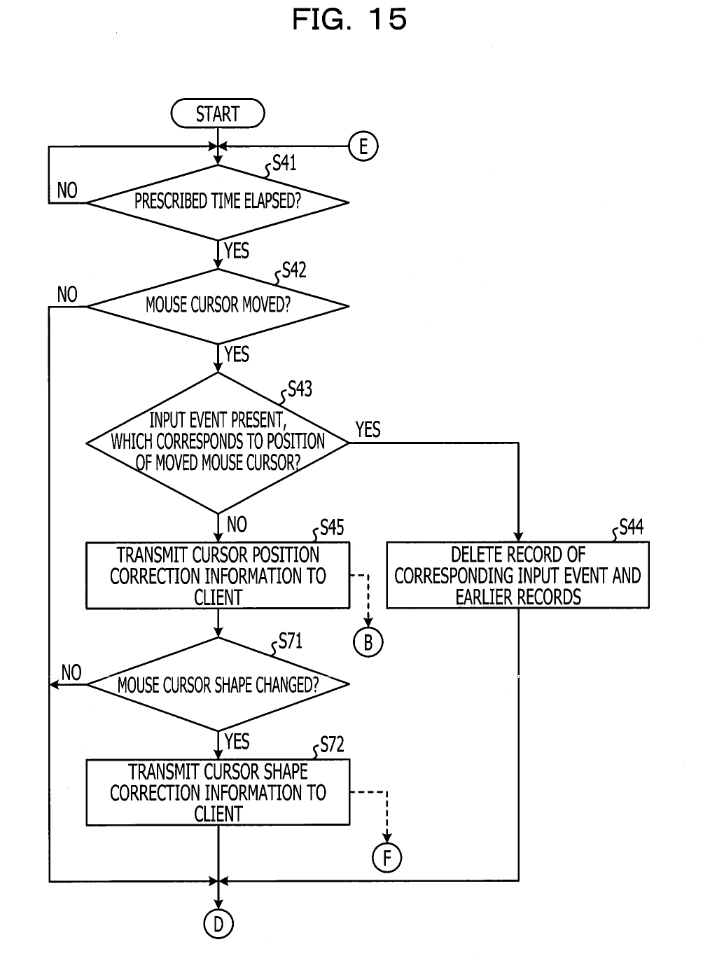

Next, a procedure of cursor position correction processing in the server 2B in the third embodiment will be described with reference to the flowchart illustrated in FIG. 15. The same processes as in cursor position correction processing executed by the server 2 in the first embodiment in FIG. 7 will be given the same symbols.

The cursor position change checking unit 231 decides whether a prescribed time has elapsed (step S41). If the cursor position change checking unit 231 decides that the prescribed time has not yet elapsed (the result in step S41 is No), the cursor position change checking unit 231 repeats this decision process until the prescribed time elapses.

If the cursor position change checking unit 231 decides that the prescribed time has elapsed (the result in step S41 is Yes), the cursor position change checking unit 231 checks whether the mouse cursor has been moved (step S42). For example, the cursor position change checking unit 231 acquires, from the OS 20, the post-processing mouse cursor position obtained as a result of having the OS 20 process the input event. The cursor position change checking unit 231 then decides whether the acquired mouse cursor position matches the mouse cursor position before the input event has been processed. The prescribed time is, for example, an interval at which one frame of screen display data is updated.

If the cursor position change checking unit 231 decides that the mouse cursor has not been moved (the result in step S42 is No), the correcting unit 23 terminates cursor position correction processing and shifts to screen information transfer processing. If the cursor position change checking unit 231 decides that the mouse cursor has been moved (the result in step S42 is Yes), the cursor position record checking unit 232 decides whether there is an input event corresponding to the position of the moved mouse cursor (step S43). For example, the cursor position record checking unit 232 decides whether the changed mouse cursor position matches any of the coordinate locations retained in the event record storage unit 21 as input event records.

If the cursor position record checking unit 232 decides that there is a corresponding input event (the result in step S43 is Yes), the cursor position record checking unit 232 deletes the record of the corresponding input event and earlier records (step S44). Then, the correcting unit 23 terminates cursor position correction processing and shifts to screen information transfer processing.

If the cursor position record checking unit 232 decides that there is no corresponding input event (the result in step S43 is No), the cursor position record checking unit 232 decides that the mouse cursor position has been automatically changed by the OS 20. The cursor position record checking unit 232 then causes the cursor position correction information transmitting unit 233 to transmit cursor position correction information to the client 1B (step S45). For example, the cursor position correction information transmitting unit 233 transmits, to the client 1B, cursor position correction information including the changed mouse cursor position.

Next, the cursor shape checking unit 401 decides whether the mouse cursor shape has been changed (step S71). If the cursor shape checking unit 401 decides that the mouse cursor shape has not been changed (the result in step S71 is No), the cursor shape checking unit 401 terminates cursor position correction processing and shifts to screen information transfer processing.

If the cursor shape checking unit 401 decides that the mouse cursor shape has been changed (the result in step S71 is Yes), the cursor shape checking unit 401 causes the cursor shape correction information transmitting unit 402 to transmit the cursor shape correction information to the client 1B (step S72). For example, the cursor shape correction information transmitting unit 402 transmits, to the client 1B, the cursor shape correction information including the changed cursor shape. Then, the correcting unit 23 terminates cursor position correction processing and shifts to screen information transfer processing.

Advantages in the Third Embodiment

In the third embodiment described above, the server 2B in the thin client system 9 receives, from the client 1B, an input event that causes the mouse cursor to move. For an input event received from the client 1B, the server 2B stores event information including a position to which to move of the mouse cursor in the event record storage unit 21. If the mouse cursor position is changed as a result of processing carried out according to the input event, the server 2B decides whether the changed mouse cursor position matches any of the mouse cursor positions retained in the event record storage unit 21. If the server 2B decides that the changed mouse cursor position does not match any of the mouse cursor positions retained in the event record storage unit 21, the server 2B notifies the client 1B of the changed mouse cursor position. Furthermore, if the mouse cursor shape is changed as a result of processing carried out according to the input event, the server 2B notifies the client 1B of the changed mouse cursor shape. Accordingly, even if the mouse cursor shape is changed after processing based on an input event received from the client 1B, the server 2B enables the client 1B to follow the changed mouse cursor shape.

### Fourth Embodiment

In the first embodiment, a case has been described in which when the mouse cursor is automatically moved as a result of input event processing, the server 2 causes the client 1 to correct the automatically moved mouse cursor. However, a movement area of the mouse cursor may be restricted in the server 2. If, in the client 1, the position of the mouse cursor to be drawn in the local echo method is in an area in which movement is restricted by the server 2, in which case when the client 1 redraws the mouse cursor at the position corrected by the server 2, the trace of movement becomes unnatural.

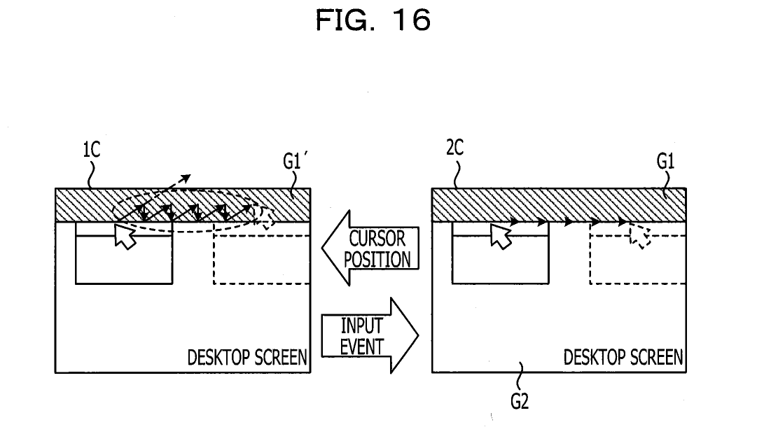

This problem with the local echo method will be described with reference to FIG. 16. As illustrated in FIG. 16, the movement of the mouse cursor is restricted in area G1 on the desktop screen of a server 2C. That is, on the desktop screen of the server 2C, the movement of the mouse cursor is allowed in area G2 other than restricted area G1. If, in this situation, input events that move the mouse cursor toward area G1′ corresponding to restricted area G1 are repeatedly generated in a client 1C, the server 2C corrects the mouse cursor position to the boundary between restricted area G1 and allowed area G2 each time the server 2C receives an input event generated in the client 1C. Thus, the server 2C transmits the corrected mouse cursor position to the client 1C. Even if the client 1C draws the mouse cursor in the local echo method at a point in time when an input event is generated, the client 1C redraws the mouse cursor at the corrected position transmitted from the server 2C, making the movement trace of the mouse cursor unnatural. In the server 2C in the example in FIG. 16, the movement trace of the mouse cursor is drawn only in the X axis (lateral direction) on the boundary between restricted area G1 and allowed area G2. In the client 1C, the movement trace of the mouse cursor is serrated vertically, resulting in an unnatural trace.

In view of the above problem, the server 2C in the fourth embodiment, which will be described below, suppresses the movement trace of the mouse cursor in the client 1C from becoming unnatural even if the movement area of the mouse cursor is restricted in the server 2C.

Structure of a Thin Client System

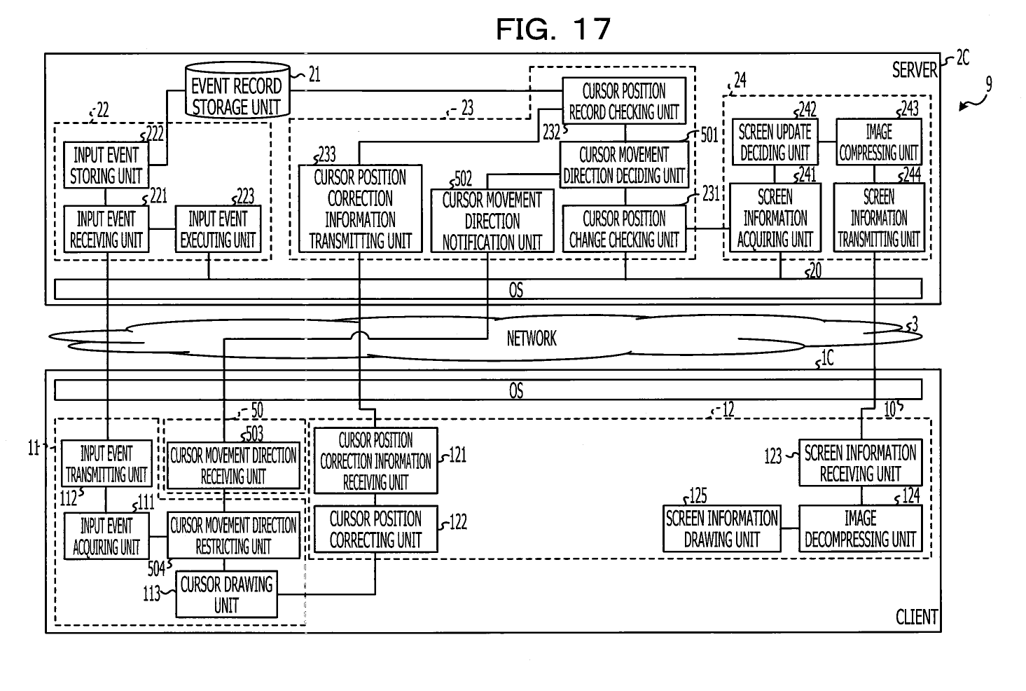

FIG. 17 is a functional block diagram illustrating the structure of a thin client system according to a fourth embodiment. Constituent elements that are the same as in the thin client system 9 illustrated in FIG. 1 will be given the same reference numerals and descriptions of duplicate structures and operations will be omitted. The fourth embodiment differs from the first embodiment in that a cursor movement direction deciding unit 501 and a cursor movement direction notification unit 502 are added to the correcting unit 23 in the server 2C. Another difference from the first embodiment is that a cursor movement direction restriction processing unit 50 is added to the event processing unit 11 in the client 1C and a cursor movement direction receiving unit 503 is added to the cursor movement direction restriction processing unit 50. Still another difference from the first embodiment is that a cursor movement direction restricting unit 504 is added to the event processing unit 11 in the client 1.

The cursor position change checking unit 231 decides whether the mouse cursor position has been changed as a result of input event execution by the input event executing unit 223.

If the mouse cursor position has been changed after the execution of the input event, the cursor movement direction deciding unit 501 determines the direction in which the mouse cursor has moved. If the cursor movement direction deciding unit 501 decides that the mouse cursor has moved only in the X-axis direction, the cursor movement direction deciding unit 501 determines that the X-axis direction as the cursor movement restricting direction. If the cursor movement direction deciding unit 501 decides that the mouse cursor has moved only in the Y-axis direction, the cursor movement direction deciding unit 501 determines that the Y-axis direction as the cursor movement restricting direction.

The cursor movement direction notification unit 502 notifies the client 1C of the cursor movement restricting direction determined by the cursor movement direction deciding unit 501.

The cursor position record checking unit 232 checks whether the changed mouse cursor position obtained after the execution of the input event is being retained in the event record storage unit 21. If the cursor movement restricting direction has been determined, the cursor position record checking unit 232 performs this check only in the determined cursor movement restricting direction. If, for example, the cursor movement restricting direction is the X-axis direction, the cursor position record checking unit 232 decides whether the X coordinate of the moved mouse cursor matches any of the X-coordinates retained in the event record storage unit 21.

If the cursor position record checking unit 232 decides that the changed mouse cursor position is being retained in the event record storage unit 21, the cursor position record checking unit 232 deletes the input event record decided to have been retained and earlier records. If the cursor position record checking unit 232 decides that the changed mouse cursor position is not being retained in the event record storage unit 21, the cursor position record checking unit 232 notifies the cursor position correction information transmitting unit 233 of the changed mouse cursor position.

The cursor movement direction receiving unit 503 receives the cursor movement restricting direction from the server 2C. The cursor movement direction restricting unit 504 restricts the mouse cursor movement direction in the client 1C to the cursor movement restricting direction received by the cursor movement direction receiving unit 503.

Specific Example of Mouse Cursor Position Correction

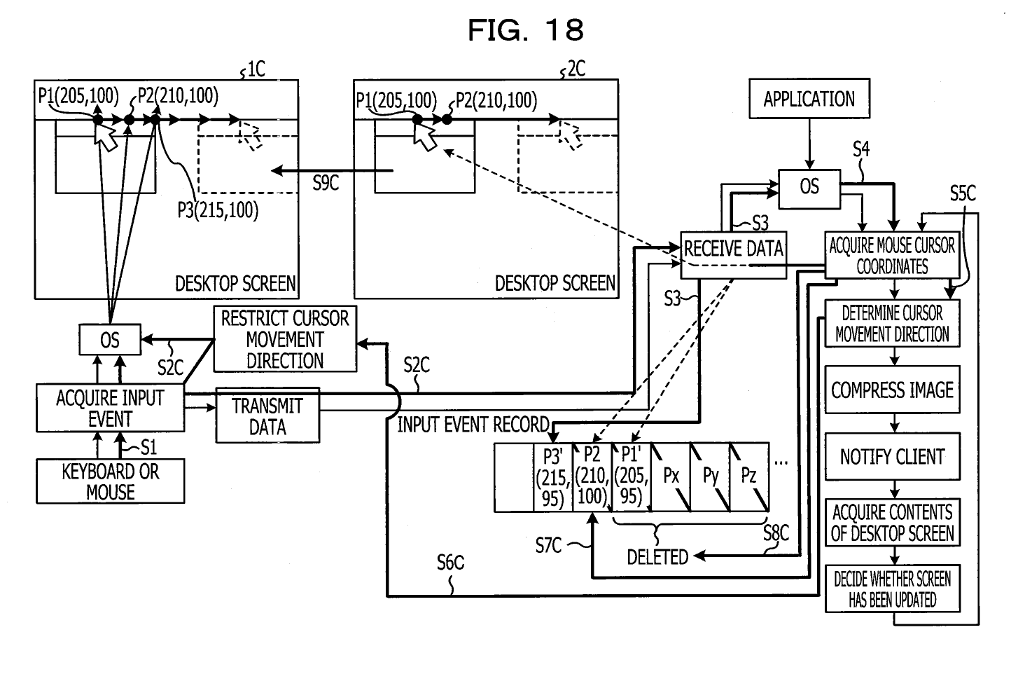

A specific example of mouse cursor position correction according to the fourth embodiment will be described with reference to FIG. 18. This example assumes that an area, on the desktop screen of the server 2C, in which the mouse cursor is movable is an area with Y coordinates of 100 or more (downward direction, in this example). That is, in the example in FIG. 18, if an attempt is made to move the mouse cursor a Y coordinate of less than 100 (upward direction in this example) on the desktop screen of the client 1C, the move-to position of the mouse cursor is corrected to a Y coordinate of 100.

As illustrated in FIG. 18, when the client 1C acquires an input event in which P1′ (205, 95) (not illustrated) is specified as a move-to position, the client 1C performs a local echo, after which the client 1C redraws the mouse cursor at a corrected position P1 (205, 100), the Y-axis value having been corrected to by the server 2C.

Next, the input event acquiring unit 111 acquires an input event in which P2 (210, 100) is specified as the move-to position of the mouse cursor (step S1). The input event acquiring unit 111 transfers the acquired input event to the input event transmitting unit 112 and cursor movement direction restricting unit 504. If the movement direction of the mouse cursor is restricted, the cursor movement direction restricting unit 504 restricts the movement direction of the mouse cursor for the transferred input event. The cursor drawing unit 113 then performs a local echo with coordinates to which the previous coordinates have been changed only in the restricted movement direction. If the movement direction of the mouse cursor is not restricted, the cursor movement direction restricting unit 504 causes the cursor drawing unit 113 to draw the mouse cursor at the coordinates specified in the input event. At that time, the input event transmitting unit 112 transmits the transferred input event to the server 2C without alteration (step S2C). Since the movement direction of the mouse cursor is not restricted here, the cursor drawing unit 113 draws the mouse cursor at P2 (210, 100).

In the server 2C, the input event receiving unit 221 receives the input event transmitted from the client 1C. The input event storing unit 222 retains the input event received by the input event receiving unit 221 as an event record. In this example, the input event storing unit 222 retains coordinates P2, which is the move-to position included in the input event, as an event record. The input event executing unit 223 causes the OS 20 to execute the input event received by the input event receiving unit 221 (step S3).

The cursor position change checking unit 231 acquires the coordinates of the mouse cursor obtained as a result of the processing by the OS 20 (step S4). Since the acquired coordinates of the mouse cursor do not match the coordinates of the mouse cursor before the processing, that is, the mouse cursor has been moved, the cursor movement direction deciding unit 501 then determines the restricted direction in mouse cursor movement (step S5C). Since, in this example, the previous coordinates are (205, 100) and the current coordinates are (210, 100), the cursor movement direction deciding unit 501 determines the X-axis direction as the restricted direction in mouse cursor movement. The cursor movement direction deciding unit 501 then causes the cursor movement direction notification unit 502 to notify the client 1C of the restricted direction (X-axis direction) of mouse cursor movement (step S6C).

The cursor position record checking unit 232 uses the determined restricted direction in mouse cursor movement to decide whether post-processing coordinates P2 of the mouse cursor is being retained as an input event record (step S7C). Since, in this example, the determined restricted direction of mouse cursor movement is the X-axis direction and X-axis coordinate 210 of post-processing coordinates P2 of the mouse cursor is being retained as an input event record, the cursor position record checking unit 232 deletes the record of coordinates P2 and earlier records (step S8C). Thus, as for an input event that moves the mouse cursor to coordinates to P2, since post-processing coordinates P2 of the mouse cursor is not automatically changed by the OS 20, processing is terminated without the client 1C correcting the coordinates. If the coordinate in the restricted direction of mouse cursor movement of the post-processing coordinates of the mouse cursor is not being retained as an input event record, the cursor position record checking unit 232 transmits the post-processing coordinates of the mouse cursor to the client 1C (step S9C).

In the client 1C, the input event acquiring unit 111 acquires a next input event (step S1). This example assumes that the input event acquiring unit 111 acquires an input event in which, for example, P3′ (215, 95) is specified as the move-to position of the mouse cursor. The input event acquiring unit 111 transfers the acquired input event to the input event transmitting unit 112 and cursor movement direction restricting unit 504. Since the movement direction of the mouse cursor is restricted to the X-axis direction, the cursor movement direction restricting unit 504 restricts the X-axis direction, which is the movement direction of the mouse cursor, for the input event. The cursor drawing unit 113 then performs a local echo with coordinates P3 (215, 100) to which previous coordinates P2 have been changed only in the restricted X-axis direction. At that time, the input event transmitting unit 112 transmits the transferred input event to the server 2C without alteration (step S2C).

The server 2C and client 1C then continue processing for input events generated in the client 1C. As described above, even if the movement area of the mouse cursor is restricted in the server 2C, the server 2C can suppress the movement trace of the mouse cursor from becoming unnatural in the client 1C.

Procedure of Input Event Processing in the Client

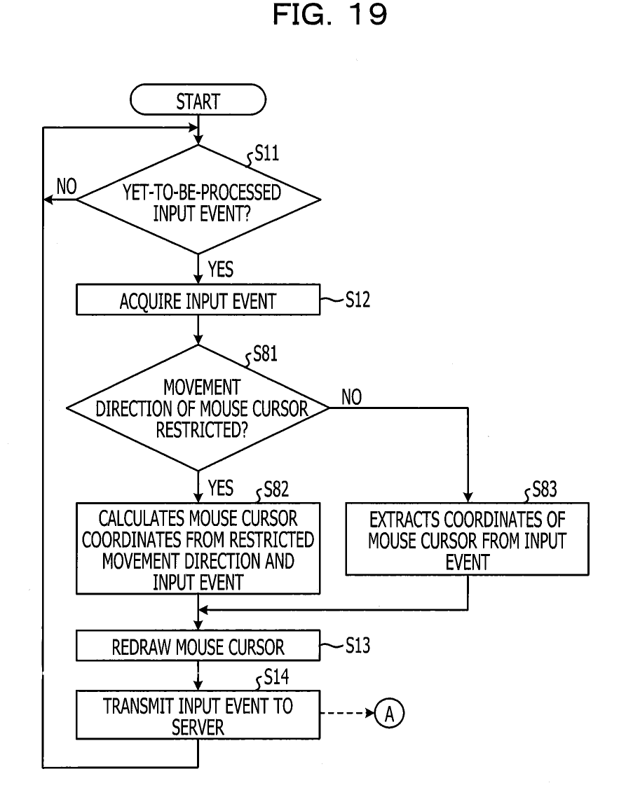

Next, a procedure of input event processing in the client 1C in the fourth embodiment will be described with reference to the flowchart illustrated in FIG. 19. The same processes as in input event processing executed by the client 1 in the first embodiment in FIG. 4 will be given the same symbols.

First, the input event acquiring unit 111 decides whether there is a yet-to-be-processed input event (step S11). If the input event acquiring unit 111 decides that there is no yet-to-be-processed input event (the result in step S11 is No), the input event acquiring unit 111 repeats this decision process until it decides that there is a yet-to-be-processed input event. If the input event acquiring unit 111 decides that there is a yet-to-be-processed input event (the result in step S11 is Yes), the input event acquiring unit 111 acquires the input event (step S12).

Then, the cursor movement direction restricting unit 504 decides whether the movement direction of the mouse cursor has been restricted (step S81). If the cursor movement direction restricting unit 504 decides that the movement direction of the mouse cursor has been restricted (the result in step S81 is Yes), the cursor movement direction restricting unit 504 calculates the coordinates of the mouse cursor from the restricted movement direction and the input event (step S82). If the cursor movement direction restricting unit 504 decides that the movement direction of the mouse cursor has not been restricted (the result in step S81 is No), the cursor movement direction restricting unit 504 extracts the coordinates of the mouse cursor from the input event (step S83).

The cursor drawing unit 113 redraws the mouse cursor on the desktop screen of the client 1C according to the calculated or extracted coordinates of the mouse cursor (step S13).

The input event transmitting unit 112 transmits the input event acquired by the input event acquiring unit 111 to the server 2C without alteration (step S14). The event processing unit 11 returns to step S11 to wait until a next event is generated.

Procedure of Cursor Movement Direction Restricting Processing in the Client

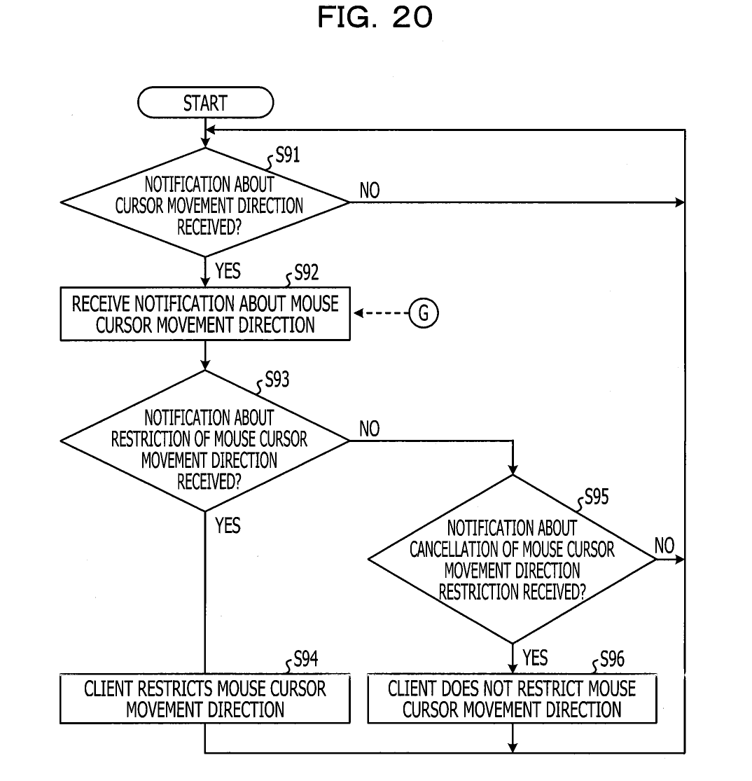

Next, a procedure of cursor movement direction restricting processing in the client 1C in the fourth embodiment will be described with reference to the flowchart illustrated in FIG. 20.

First, the cursor movement direction receiving unit 503 decides whether a notification about the cursor movement direction has been received from the server 2C (step S91). If the cursor movement direction receiving unit 503 decides that a notification about the cursor movement direction has not been received (the result in step S91 is No), the cursor movement direction receiving unit 503 repeats this decision process until a notification about the cursor movement direction is received.

If the cursor movement direction receiving unit 503 decides that a notification about the cursor movement direction has been received (the result in step S91 is Yes), the cursor movement direction receiving unit 503 receives a notification about mouse cursor movement direction (step S92).

The cursor movement direction receiving unit 503 then decides whether a notification about a restricted mouse cursor movement direction has been received (step S93). If the cursor movement direction receiving unit 503 decides that a notification about a restricted mouse cursor movement direction has been received (the result in step S93 is Yes), the cursor movement direction restricting unit 504 controls the client 1C so that it restricts the movement direction of the mouse cursor (step S94). The cursor movement direction restriction processing unit 50 returns to step S91 to wait for a next notification about the mouse cursor movement direction.

If the cursor movement direction receiving unit 503 decides that a notification about a restricted mouse cursor movement direction has not been received (the result in step S93 is No), the cursor movement direction receiving unit 503 decides whether a notification about mouse cursor movement direction restriction cancellation has been received (step S95). If the cursor movement direction receiving unit 503 decides that a notification about mouse cursor movement direction restriction cancellation has not been received (the result in step S95 is No), the cursor movement direction restriction processing unit 50 returns to step S91 to wait for a next notification about the mouse cursor movement direction.

If the cursor movement direction receiving unit 503 decides that a notification about mouse cursor movement direction restriction cancellation has been received (the result in step S95 is Yes), the cursor movement direction restricting unit 504 controls the client 1C so that it does not restrict the movement direction of the mouse cursor (step S96). The cursor movement direction restriction processing unit 50 then returns to step S91 to wait for a next notification about the mouse cursor movement direction.

Procedure of Cursor Position Correction Processing in the Server

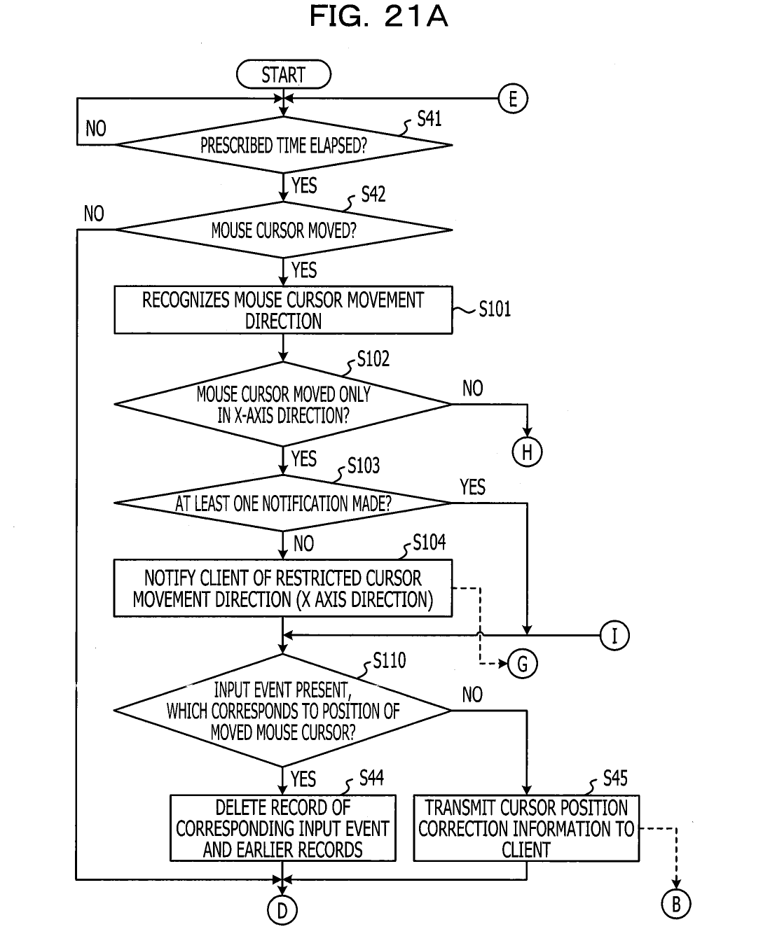

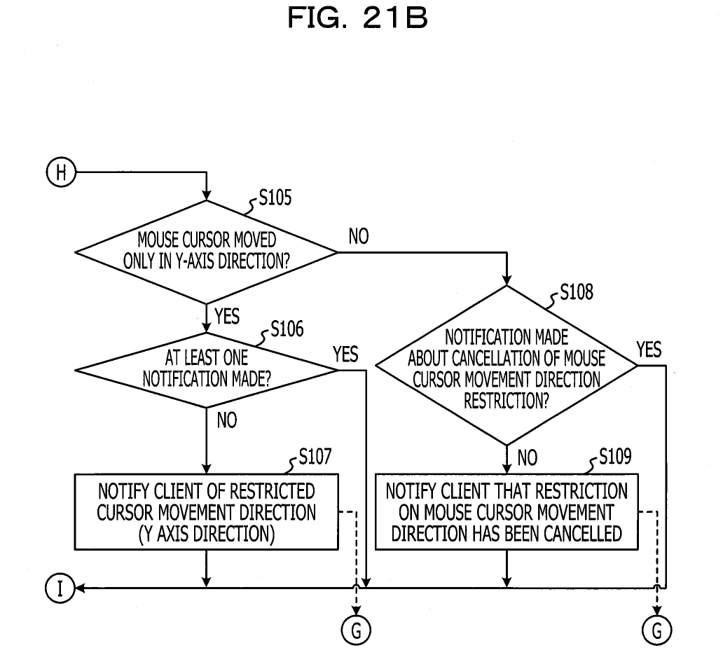

Next, a procedure of cursor position correction processing in the server 2C in the fourth embodiment will be described with reference to the flowchart illustrated in FIGS. 21A and 21B. The same processes as in cursor position correction processing executed by the server 2 in the first embodiment in FIG. 7 will be given the same symbols.

The cursor position change checking unit 231 decides whether a prescribed time has elapsed (step S41). If the cursor position change checking unit 231 decides that the prescribed time has not yet elapsed (the result in step S41 is No), the cursor position change checking unit 231 repeats this decision process until the prescribed time elapses.

If the cursor position change checking unit 231 decides that the prescribed time has elapsed (the result in step S41 is Yes), the cursor position change checking unit 231 checks whether the mouse cursor has been moved (step S42).

If the cursor position change checking unit 231 decides that the mouse cursor has not been moved (the result in step S42 is No), the correcting unit 23 terminates cursor position correction processing and shifts to screen information transfer processing. If the cursor position change checking unit 231 decides that the mouse cursor has been moved (the result in step S42 is Yes), the cursor movement direction deciding unit 501 recognizes a direction in which the mouse cursor has been moved (step S101). Specifically, the cursor movement direction deciding unit 501 decides whether the mouse cursor has been moved only in the X-axis direction (step S102).

If the cursor movement direction deciding unit 501 decides that the mouse cursor has been moved only in the X-axis direction (the result in step S102 is Yes), the cursor movement direction deciding unit 501 decides whether at least one notification of the restricted mouse cursor movement direction (X-axis direction) has been made (step S103). If the cursor movement direction deciding unit 501 decides that at least one notification of the restricted mouse cursor movement direction has been made (the result in step S103 is Yes), the cursor movement direction deciding unit 501 decides that no more notifications are desired and the sequence proceeds to step S110. If the cursor movement direction deciding unit 501 decides that no notification has been made (the result in step S103 is No), the cursor movement direction notification unit 502 notifies the client 1C of the X-axis direction as the restricted mouse cursor movement direction (step S104) and causes the sequence to proceed to step S110.

If the cursor movement direction deciding unit 501 decides that the mouse cursor has not been moved only in the X-axis direction (the result in step S102 is No), the cursor movement direction deciding unit 501 decides whether the mouse cursor has been moved only in the Y-axis direction (step S105).

If the cursor movement direction deciding unit 501 decides that the mouse cursor has been moved only in the Y-axis direction (the result in step S105 is Yes), the cursor movement direction deciding unit 501 decides whether at least one notification of the restricted mouse cursor movement direction (Y-axis direction) has been made (step S106). If the cursor movement direction deciding unit 501 decides that at least one notification of the restricted mouse cursor movement direction has been made (the result in step S106 is Yes), the cursor movement direction deciding unit 501 decides that no more notifications are desired and causes the sequence to proceed to step S110. If the cursor movement direction deciding unit 501 decides that no notification has been made (the result in step S106 is No), the cursor movement direction notification unit 502 notifies the client 1C of the Y-axis direction as the restricted mouse cursor movement direction (step S107) and causes the sequence to proceed to step S110.

If the cursor movement direction deciding unit 501 decides that the mouse cursor has not been moved only in the Y-axis direction (the result in step S105 is No), the cursor movement direction deciding unit 501 decides whether a notification about mouse cursor movement direction restriction cancellation has been made (step S108). If the cursor movement direction deciding unit 501 decides that a notification about mouse cursor movement direction restriction cancellation has been made (the result in step S108 is Yes), the cursor movement direction deciding unit 501 decides that no more notifications are desired and causes the sequence to proceed to step S110. If the cursor movement direction deciding unit 501 decides that a notification about mouse cursor movement direction restriction cancellation has not been made (the result in step S108 is No), the cursor movement direction notification unit 502 notifies the client 1C that the restriction on the mouse cursor movement direction has been cancelled (step S109) and causes the sequence to proceed to step S110.

The cursor position record checking unit 232 decides whether there is an input event corresponding to the position of the moved mouse cursor (step S110). For example, the cursor position record checking unit 232 decides whether the changed mouse cursor position matches any of the coordinate locations retained in the event record storage unit 21 as input event records. In this case, if the mouse cursor movement direction is being restricted, the cursor position record checking unit 232 may check only coordinates on the restricted coordinate axis.

If the cursor position record checking unit 232 decides that there is a corresponding input event (the result in step S110 is Yes), the cursor position record checking unit 232 deletes the record of the corresponding input event and earlier records (step S44). Then, the correcting unit 23 terminates cursor position correction processing and shifts to screen information transfer processing.

If the cursor position record checking unit 232 decides that there is no corresponding input event (the result in step S110 is No), the cursor position record checking unit 232 decides that the mouse cursor position has been automatically changed by the OS 20. The cursor position record checking unit 232 then causes the cursor position correction information transmitting unit 233 to transmit cursor position correction information to the client 1C (step S45). Then, the correcting unit 23 terminates cursor position correction processing and shifts to screen information transfer processing.

Advantages in the Fourth Embodiment

In the fourth embodiment described above, if the mouse cursor position is changed as a result of processing carried out according to the input event, the server 2C in the thin client system 9 decides whether the mouse cursor positions before and after the processing differ only in one axial direction. If the server 2C decides that the mouse cursor positions differ only in one axial direction, the server 2C decides whether in that axial direction, which has the changed mouse cursor position, the changed mouse cursor position matches any of the mouse cursor positions retained in the event record storage unit 21. Accordingly, since the server 2C uses a mouse cursor position in an axial direction, which has the changed mouse cursor position, to make comparisons with mouse cursor positions retained in the event record storage unit 21, costs involved in comparison processing can be reduced.

If the server 2C decides that the mouse cursor position has changed only in one axial direction, the server 2C notifies the client 1C that mouse cursor movement will be restricted to that axial direction. Accordingly, even if the movement area of the mouse cursor is restricted in the server 2C, the movement trace of the mouse cursor in the client 1C can be controlled so that the movement trace becomes natural.

Programs and the Like

The first to fourth embodiments have been described for a case in which the post-processing mouse cursor position has been changed by the OS 20. However, this is not a limitation. The post-processing mouse cursor position may be changed by a driver or application software instead of the OS 20; any software or hardware is applicable if it automatically changes the post-processing mouse cursor position.

The server 2 can be implemented by mounting the event processing unit 22, correcting unit 23, transfer unit 24, and other functions described above in a known personal computer, workstation, or another information processing apparatus. The client 1 can be implemented by mounting the event processing unit 11, drawing unit 12, and other functions described above in a known personal computer, workstation, or another information processing apparatus.

The physical layouts of the components of the illustrated apparatuses are not limited to those illustrated. That is, specific distribution and integration of these components are not limited to those illustrated. Part or all of the components may be functionally or physically distributed or integrated in a desired unit. For example, the cursor position change checking unit 231 and cursor position record checking unit 232 may be combined into one unit. Conversely, the cursor position record checking unit 232 may be divided into a deciding unit that decides whether the mouse cursor position is being retained as a record and a deleting unit that deletes the record if the mouse cursor position is being retained. The event record storage unit 21 and other storage units may be external units connected to the server 2 via a network.

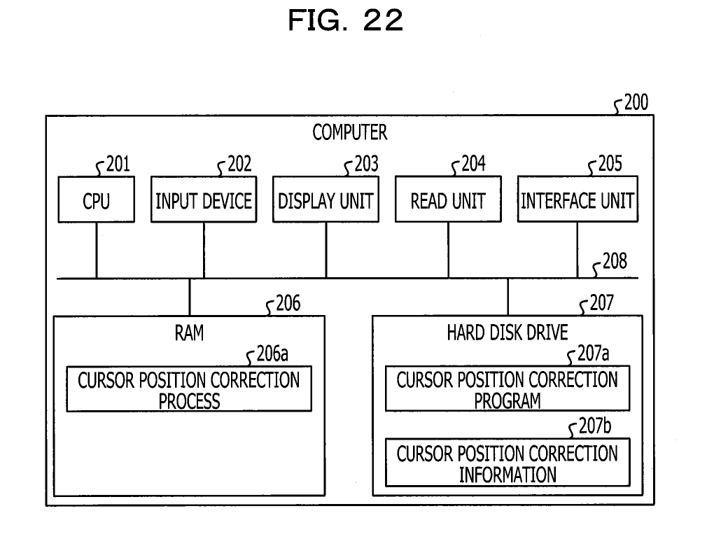

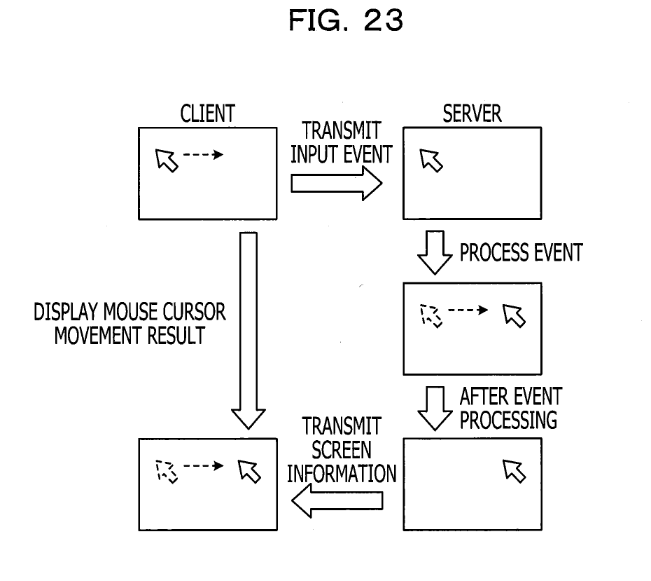

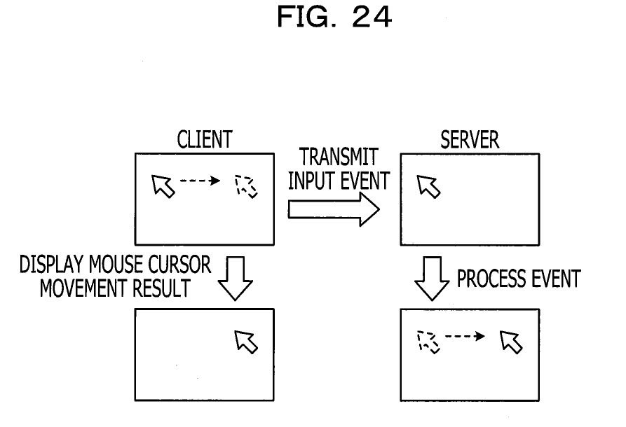

The processes described in the above embodiments can be implemented by causing a personal computer, a workstation, or another type of computer to execute programs prepared in advance. An example of a computer that executes a cursor position correction program implementing the same function as the server 2 illustrated in FIG. 1 will be described below with reference to FIG. 22.

As illustrated in FIG. 22, the computer 200 includes a CPU 201, an input unit 202 that receives inputs from a user, and a display unit 203. The computer 200 also includes a read unit 204 that reads out programs and the like from a storage medium as well as an interface unit 205 that transmits and receives data to and from another computer through a network. The computer 200 also includes a random-access memory (RAM) 206 and a hard disk drive 207. These components 201 to 207 are connected to a bus 208.

The hard disk drive 207 stores a cursor position correction program 207a and cursor position correction information 207b. The CPU 201 reads out the cursor position correction program 207a and stores it in the RAM 206. The cursor position correction program 207a functions as a cursor position correction process 206a.

For example, the cursor position correction process 206a corresponds to the event processing unit 22, correcting unit 23, and transfer unit 24. The cursor position correction information 207b corresponds to the event record storage unit 21.

The cursor position correction program 207a may not be stored in the hard disk drive 207 in advance. For example, the cursor position correction program 207a may be prestored on a flexible disc (FD), a compact disc-read-only memory (CD-ROM), a digital versatile disc (DVD), a magneto-optic disc, an integrated circuit (IC) card, or another portable physical medium, which is inserted into the computer 200. The computer 200 may read out the cursor position correction program 207a from the alternative medium.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A pointer position correction method executed by a server, the correction method comprising:
receiving, from a client connected to the server through a network, first event information including an event that causes a pointer to move and a position to which to move the pointer, the event being input by the client;
storing the first event information in an event record storage medium that stores a plurality of event information;
executing processing according to the event that is included in the first event information;
deciding whether, if the position of the pointer has been changed as a result of executing the processing, the changed pointer position matches any of pointer positions in the plurality of event information stored in event record storage medium; and
notifying the client of the changed pointer position if the changed pointer position does not match any of the pointer positions in the plurality of event information.

2. The method according to claim 1 further comprising, if the changed pointer position matches any of the pointer positions in the plurality of event information, deleting second event information including the matching pointer position and at least one third event information received before the first event information received from the client.

3. The method according to claim 1 further comprising, if the changed pointer position matches any of the pointer positions in the plurality of event information and a total of event information including the matching pointer position and event information received before the first event information is larger than a threshold, prolonging a current interval at which the processing is executed according to another event.

4. The method according to claim 1 further comprising, if a shape of the pointer has been changed as a result of executing the processing, notifying the client of the changed shape of the pointer.

5. The method according to claim 1, wherein, in the deciding:
if the position of the pointer has been changed as a result of executing the processing, whether the pointer position before the processing and the changed pointer position after the processing differ only in one axial direction of axes of coordinates representing the position of the pointer is decided; and
if the pointer position before the processing and the changed pointer position after the processing differ only in the one axial direction is decided, whether the changed pointer position matches any of pointer positions in the plurality of event information in the one axial direction.

6. The method according to claim 5, wherein, if it is decided that the pointer position before the processing and the changed pointer position after the processing differ only in the one axial direction, notifying the client that movement of the pointer will be restricted to the axial direction in which the pointer position before the processing and the changed pointer position after the processing differ.

7. A storage medium storing a pointer position correction program that causes a server to execute operations, the operations comprising:
receiving, from a client connected to the server through a network, first event information including an event that causes a pointer to move and a position to which to move the pointer, the event being input by the client;
storing the first event information in an event record storage medium that stores a plurality of event information;
executing processing according to the event that is included in the first event information;
deciding whether, if the position of the pointer has been changed as a result of executing the processing, the changed pointer position matches any of pointer positions in the plurality of event information stored in event record storage medium; and
notifying the client of the changed pointer position if the changed pointer position does not match any of the pointer positions in the plurality of event information.

8. The storage medium according to claim 7, wherein the operations further comprise, if the changed pointer position matches any of the pointer positions n the plurality of event information, deleting second event information including the matching pointer position and at least one third event information received before the first event information.

9. The storage medium according to claim 7, wherein the operations further comprise, if the changed pointer position matches any of the pointer positions in the plurality of event information and a total of event information including the matching pointer position and event information received before the first event information is larger than a threshold, prolonging a current interval at which the processing is executed according to another event.

10. The storage medium according to claim 7, wherein the operations further comprise, if a shape of the pointer has been changed as a result of executing the processing, notifying the client of the changed shape of the pointer.

11. The storage medium according to claim 7, wherein, in the deciding in the operations, the server:
if the position of the pointer has been changed as a result of executing the processing, decides whether the pointer position before the processing and the changed pointer position after the processing differ only in one axial direction of axes of coordinates representing the position of the pointer; and
if the pointer position before the processing and the changed pointer position after the processing differ only in the one axial direction is decided, decides whether the changed pointer position matches any of pointer positions in the plurality of event information in the one axial direction.

12. The storage medium according to claim 11, wherein, if it is decided that the pointer position before the processing and the changed pointer position after the processing differ only in the one axial direction, the client is notified that movement of the pointer will be restricted to the axial direction in which the pointer position before the processing and the changed pointer position after the processing differ.

13. A server comprising:
a processor to execute a procedure, the procedure comprising:
receiving, from a client connected to the server through a network, first event information including an event that causes a pointer to move and a position to which to move the pointer, the event being input by the client,
storing the first event information in memory that stores a plurality of event information,
executing processing according to the event that is included in the first event information,
deciding whether, if the position of the pointer has been changed as a result of executing the processing, the changed pointer position matches any of pointer positions in the plurality of event information stored in the memory, and
notifying the client of the changed pointer position if the changed pointer position does not match any of the pointer positions in the plurality of event information.

14. The server according to claim 13, wherein if the changed pointer position matches any of the pointer positions in the plurality of event information, the processor deletes second event information including the matching pointer position and at least one third event information received before the first event information received.

15. The server according to claim 13, wherein if the changed pointer position matches any of the pointer positions in the plurality of event information and a total of event information including the matching pointer position and event information received before the first event information is larger than a threshold, the processor prolongs a current interval at which the processing is executed according to another event.

16. The server according to claim 13, wherein if a shape of the pointer has been changed as a result of executing the processing, the processor notifies the client of the changed shape of the pointer.

17. The server according to claim 13, wherein
if the position of the pointer has been changed as a result of executing the processing, the processor further decides whether the pointer position before the processing and the changed pointer position after the processing differ only in one axial direction of axes of coordinates representing the position of the pointer is decided; and
if the processor decides that the pointer position before the processing and the changed pointer position after the processing differ only in the one axial direction, the processor further decides whether the changed pointer position matches any of pointer positions in the plurality of event information in the one axial direction.

18. The server according to claim 17, wherein if the processor decides that the pointer position before the processing and the changed pointer position after the processing differ only in the one axial direction, the processor notifies the client that movement of the pointer will be restricted to the axial direction in which the pointer position before the processing and the changed pointer position after the processing differ.
